(19) United States
(12) Patent Application Publication
(10) Pub. No.: US 2025/0230784 A1
(43) Pub. Date: Jul. 17, 2025

(54) NOZZLE COOLING DEVICE OF A ROCKET ENGINE AND A REGENERATIVE COOLING SYSTEM OF A HYBRID ROCKET ENGINE

(71) Applicant: Letara Ltd., Sapporo-shi (JP)

(72) Inventors: Landon Thomas Kamps, Sapporo-shi (JP); Shota Hirai, Sapporo-shi (JP); Harunori Nagata, Sapporo-shi (JP); Giuseppe Gallo, Sapporo-shi (JP); Hiroki Kojima, Sapporo-shi (JP); Yuki Nobuhara, Sapporo-shi (JP); Carmine Carmicino, Firenze (IT)

(73) Assignee: Letara Ltd., Sapporo-shi (JP)

(21) Appl. No.: 19/004,995

(22) Filed: Dec. 30, 2024

(30) Foreign Application Priority Data
Jan. 17, 2024 (JP) 2024- 005546

(51) Int. Cl. F02K 9/97

(52) U.S. Cl. CPC F02K 9/972

(57) ABSTRACT

A cooling device for rocket engine nozzle comprising a first member including a cylindrical or tapered inner circumstance shape, channels provided over the part or all of the inner circumstance surface, and a helical groove part on each channel, and a second member including an outer circumstance surface of being the substantially same shape as the inner circumferential surface of the first member, and a nozzle-shaped cavity part therein to form a nozzle part, and then by assembling both of the members, forming tube parts corresponding to the shape of the helical groove parts as helical cooling channels placed on positions spaced predetermined distances from a throat part of the nozzle part, by which preventing coolant running in the helical cooling channels from excessively heated and helping the coolant perform its designed cooling ability to suppress nozzle erosion, upon flue gas of the rocket engine passing through the throat part.

### BACKGROUND OF THE INVENTION

### Field of the Invention

The present disclosure relates to cooling of rocket engines, particularly to regenerative cooling of hybrid rocket engines.

### Description of the Related Art

Known types of rocket engines include solid-fuel rockets, liquid-fuel rockets, and hybrid rockets that combine the advantages of both.

The combustion gases of a rocket engine reach exceptionally high temperatures and pressures when passing through the combustion chamber's nozzle; therefore, cooling is needed to prevent damage or erosion of the combustion chamber or nozzle.

On the other hand, adding a dedicated cooling device has disadvantages, such as hindering the rocket propulsion system's weight reduction and increasing cost.

Therefore, a method called regenerative cooling has been adopted. In this method, fuel and other contents of rocket engines are used to cool the combustion chamber or nozzle.

For instance, Patent Document 1, “Combustion Chamber Liner with Spiral Cooling Channels,” discloses a technique for combustion chamber liners that uses a spiral cooling chamber to cool the combustion chamber regeneratively during operation.

However, the technique described in Patent Document 1, which uses spiral cooling channels, has disadvantages; it has more than 50 configuration channels, and the cooling ability is not sufficiently improved compared to a cooling channel configured from axial straight channels. The cause is the insufficient heat exchange between its combustion chamber and the nozzle, which occurs because the coolant passes through the coolant channel without enough resistance (See FIG. 1).

Patent Document 2 shows a technique against the disadvantages above.

Patent Document 2, “Methane Engine for Rocket Propulsion,” discloses a technique for supplying propellant to combustion chambers and nozzles to conduct regenerative cooling.

In the technique of Patent Document 2, since the number of cooling channels is small, at only one, pressure loss is significant, and the coolant tends to flow slowly through the cooling channel, sufficient heat exchange is achieved, promising high cooling ability.

### CITATION LIST

### Patent Literature

### [Patent Literature 1]

Japanese Translation of PCT International Application Publication No. 2022-514200

### [Patent Literature 2]

Japanese Translation of PCT International Application Publication No. 2009-540190

### Problem(s) to be Solved by the Invention

In the techniques disclosed in Patent Document 2, however, cooling channels with spiral structures are formed over the entire length of the nozzle, thereby excessively heating the coolant passing through them. Depending on the coolant used, there is a risk that an explosive phenomenon may occur within the cooling channels, damaging the cooling channels or the combustion chamber (see FIG. 2).

Furthermore, a problem to be solved common to Patent Documents 1 and 2 is that due to cooling channels are provided along the nozzle shape, which is narrow and tapered in the center (without being spaced apart from the nozzle, where the temperature becomes very high). Hence, the cooling channels are directly affected by the temperature rise in the combustion chamber or nozzle.

In addition, the technique in Patent Document 1 provides for using a metallic nozzle such as copper; Patent Document 2 also assumes using a metallic nozzle due to adopting a liquid fuel system.

For this reason, nozzles made of metallic materials such as copper, whose thermal conductivity significantly exceeds 200 W/(m·K), transfer the heat of the high-temperature combustion gas of 2500 to 3000 degrees inside the nozzle directly to the coolant flowing in the cooling channel, causes accelerating the rise in the coolant's temperature.

From the above, the techniques in Patent Document 1 and Patent Document 2, the positional relationship between combustion chambers or nozzles and cooling channels, and the thermal conductivity of the nozzle material, are not sufficiently considered.

Furthermore, the techniques in Patent Documents 1 and 2 are intended to provide regenerative cooling for nozzles of solid fuel rockets, liquid fuel rockets, etc., and do not provide solutions to the problems specific to hybrid rocket engines.

Hence, the characteristic problems of hybrid rocket engines that need to be solved are described below.

Hybrid rockets enplane fuel in solid and oxidizer in liquid, so the fuel and oxidizer do not mix naturally, achieving safe operation without explosion risks.

Oxygen or hydrogen peroxide is generally used as the oxidizer for hybrid rockets, and hydrocarbon polymers such as polyethylene, polypropylene, and acrylic resin can be used as solid fuel, which makes it possible to manufacture hybrid rockets more inexpensively than solid-fuel rockets.

Some combinations of these oxidizers and solid fuels are known to provide 10% higher thrust than solid propellant used for solid-fuel rockets and are available as high-performance rocket engines.

In addition, by controlling the flow rate of the oxidizer, the engine output can be adjusted, stopped, and reignited, making it usable as a highly functional rocket engine.

In this way, hybrid rockets have advantages in terms of safety, high thrust, and combustion cut-off/re-ignition/thrust control.

In engine operation, a high-pressure gas and pump-pressurized liquid oxidizer is blown into a combustion chamber filled with solid fuel and ignited by a separately provided ignition device, forming a flame on the surface of the solid fuel.

The flame's heat decomposes, melts, and vaporizes the solid fuel. At the same time, the heat transits the oxidizer into an oxidizing gas, and these gases maintain the flame by convection or diffusion.

However, the combustion is maintained by a phenomenon called boundary layer combustion, which occurs in a boundary layer a few millimeters from the surface of solid fuel. Hence, unlike the combustion of solid and liquid propellants, where tens of micrometers separate flame and fuel, the heat supply to the fuel is not necessarily sufficient.

Therefore, the research team for the present disclosure investigated whether it could supply a high amount of heat to fuel by using nitrous oxide as an oxidizer instead of relatively safe liquid oxygen or hydrogen peroxide. Upon thermal decomposition, nitrous oxide produces a mixed gas with a higher oxygen partial pressure than the atmosphere.

Nitrous oxide (N2O) has a high vapor pressure at room temperature (approximately 50 bar), which means it can be discharged from the tank without complex pumps or pressurization systems usually required: it is self-pressurized, reducing the weight of the entire propulsion system, and simplifying its design.

On the other hand, it is found that in the case of liquid nitrous oxide, if helical cooling channels are formed along the shape of a nozzle, the nitrous oxide would cause a sudden temperature change due to the combustion temperature inside the nozzle, resulting in an explosive phenomenon and a risk of destruction of the cooling channel and nozzle. This is because nitrous oxide (N2O) has a critical temperature of 36.5° C., close to room temperature, and may reach its critical temperature due to the temperature rise caused by heat exchange with the nozzle.

In addition, oxygen does not reach a critical state, either in liquid or gas form, so significant measures are not needed to prevent the coolant from overheating, and there is no problem with the cooling function. However, it was discovered that when nitrous oxide was used to increase combustion efficiency, the nozzle would melt from the heat, causing rapid erosion.

Therefore, the objectives of the present disclosure are to provide cooling devices for rocket engines (hereinafter referred to as a “nozzle cooling device” or simply “cooling device”) and regenerative cooling systems that suppress nozzle erosion by using helical cooling channels, which are highly safe and do not cause explosive phenomena even when nitrous oxide is used as an oxidizer in hybrid rocket engines.

The present disclosure also aims to provide nozzle cooling devices and regenerative cooling systems suitable for hybrid engines under consideration for the positional relationship between combustion chambers or nozzles and cooling channels and balancing the temperature rise of coolant and the cooling ability.

The present disclosure also aims to balance the coolant's temperature rise and cooling ability by providing a cooling channel for each channel section and considering the number of cooling channels.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

### SUMMARY OF THE INVENTION

In response to the above issue, the first aspect of the present disclosure is a cooling device having a coolant inlet and a coolant outlet to cool a rocket engine nozzle. The cooling device includes:
a first member, which has an inner circumstance surface with a substantially cylindrical or tapered shape on the inner circumstance surface, including I channels provided over a part or all of the inner circumstance surface, wherein “I” is an integer of two or more to n, and a helical groove part on each channel;
a second member, which has an outer shape being as a substantially cylindrical or tapered shape, an outer circumstance surface being substantially a same shape as the inner circumferential surface of the first member, wherein
   upon the second member being fitted onto the inner circumferential surface of the first member, the outer circumferential surface of the second member being a shape to be substantially flushed to the inner circumferential surface of the first member,
   a nozzle-shaped cavity part being provided inside of the second member for the sake of forming a nozzle part of the rocket engine, and
   a predetermined distance (ds) being secured between a throat part of the nozzle part and the outer circumferential surface; and
a device to form a helical cooling channel between the inner circumferential surface of the first member and the outer circumferential surface of the second member by assembling the first member and the second member, the device includes:
   a tube part being provided as corresponding to the helical groove part shape between the helical groove part provided at the inner circumferential surface of the first member and the outer circumferential surface of the second member, and thereby the helical cooling channel being formed; and
   the helical cooling channel being provided at a position spaced a predetermined distance (ds) from the throat part formed inside of the second member,
   followed by preventing coolant running in the helical cooling channel from being excessively heated and helping the coolant perform a predetermined cooling ability upon a combustion gas of the rocket engine passing through the throat part.

The second aspect relates to
the cooling device for a rocket engine nozzle described in the first aspect, and the first member is characterized
   the helical groove part provided at a position corresponding to the throat part of the nozzle part, the position being a part of the inner circumferential surface of the first member,
   upon forming the helical cooling channel by forming the tube part corresponding to the shape of the helical groove part between the helical groove part and the outer circumferential surface of the second member, the helical cooling channel is formed at a position spaced the predetermined distance (ds) from the throat part formed inside of the second member and, furthermore
   an effective width of the helical cooling channel (hw) is shorter than the total length of the nozzle part.

The third aspect relates to
the cooling device for a rocket engine nozzle described in the second aspect, and
the second member is made of a predetermined thermal conductive material, including graphite, whereby, it is characterized that
   upon a combustion gas of the rocket engine passing through the nozzle part, transferring heat received at the nozzle part of the second member to a coolant running through the helical cooling channel via the predetermined thermal conductive material,
   demonstrating a predetermined cooling ability against the nozzle part by a heat-exchanging function of the coolant,
   the helical cooling channel being formed at the position spaced the predetermined distance (ds) from the throat part formed inside of the second member,
   providing a device for decreasing a temperature gradually depending on the distance from the nozzle part, which is a heat-source, by using the predetermined thermal conductive material, and then
   upon the combustion gas of the rocket engine passing through the nozzle part, preventing the coolant running in the helical cooling channel from being excessively heated.

The fourth aspect relates to
the cooling device for a rocket engine nozzle described in any one of the second or third aspects, wherein
   upon using nitrous oxide as the coolant running in the helical cooling channel,
   for the sake of preventing the combustion gas of the rocket engine from suddenly heating the nitrous oxide as the coolant and causing an explosive phenomenon, thereby the helical cooling channel or the nozzle part being destroyed,
   forming the helical cooling channel at a position spaced the predetermined distance (ds) from the throat part of the nozzle part formed inside of the second member, and
   the effective width of the helical cooling channel is shorter than the total length of the nozzle throat.

The fifth aspect relates to
the cooling device for a rocket engine nozzle described in any one of the second or third aspects, wherein
   the predetermined distance (ds) provided between the helical cooling channel and the throat part of the nozzle part is at least twice the diameter of the throat part of the nozzle part (nsd), and
   the effective width of the helical cooling channel (hw) having a width of one-third to one-half with respect to the total length of the second member (nzl).

The sixth aspect relates to
the cooling device for a rocket engine nozzle described in any one of the second or third aspects, and the first member is characterized in that
   the helical groove part is provided at the position corresponding to the throat part of the nozzle part, the position being a part of the inner circumferential surface of the first member, and
   upon forming a tube part corresponding to the helical groove part shape between the helical groove part and the second member, thereby forming the helical cooling channel,
   the helical groove part having a swirl angle α of 2 to 10 degrees.

The seventh aspect relates to
the cooling device for a rocket engine nozzle described in any one of the second or third aspects, and
   the first member is characterized in that the helical groove part is provided at the position corresponding to the throat part of the nozzle part, the position being a part of the inner circumferential surface of the first member, and
   upon forming a tube part corresponding to the helical groove part shape between the helical groove part and the second member, the number of channels of the helical groove part “I” being 2 to 8.

The eighth aspect relates to
the cooling device for a rocket engine nozzle described in the seventh aspect, the first member is characterized in that
   an introduction zone for introducing a coolant into the cooling channel is provided on a portion of the inner circumferential surface thereon and,
   a recovery zone for recovering the coolant having elevated temperature due to running through the cooling channel is provided, and thereby
   even when the number of cooling channels I is as small as 2 to 8, allowing smooth introduction and recovery of the coolant to the cooling channels.

The ninth aspect relates to
a regenerative cooling system for a hybrid rocket engine, especially for the nozzle part of the hybrid rocket engine. The regenerative cooling system includes: an oxidizer in a liquid phase; an oxidizer storage part for storing the oxidizer in a liquid phase; an oxidizer injection part for injecting the oxidizer; a solid fuel part serving as a rocket propellant; an ignition part for causing a combustion reaction between the oxidizer and the solid fuel; a nozzle part for accelerating the combustion gas generated by the combustion of the solid fuel to supersonic speed; and a cooling channel for utilizing the oxidizer to cool the nozzle part,
wherein
a first member, as a member for regenerative cooling, includes
a substantially cylindrical or tapered shape on an inner circumstance surface,
including I channels provided over a part or all of the inner circumstance surface, wherein “I” is an integer of two or more to n, and a helical groove part on each channel,
a second member, as a member including the nozzle part that is a target of regenerative cooling, the second member includes:
   an outer shape being a substantially cylindrical or tapered shape;
   an outer circumstance surface being substantially the same shape as the inner circumferential surface of the first member, wherein
   upon the second member being fitted onto the inner circumferential surface of the first member, the outer circumferential surface of the second member being a shape to be substantially flushed to the inner circumferential surface of the first member;
   a nozzle-shaped cavity part being provided inside of the second member for the sake of forming a nozzle part of the rocket engine; and
   a predetermined distance (ds) being secured between a throat part of the nozzle part and the outer circumferential surface, and
a device to form a helical cooling channel between the inner circumferential surface of the first member and the outer circumferential surface of the second member by assembling the first member and the second member, the device includes
   a tube part being provided as corresponding to the helical groove part shape between the helical groove part provided at the inner circumferential surface of the first member and the outer circumferential surface of the second member, and thereby the helical cooling channel being formed,
   the helical cooling channel being provided at a position spaced a predetermined distance (ds) from the throat part formed inside of the second member,
   followed by preventing coolant running in the helical cooling channel from being excessively heated and helping the coolant perform a predetermined cooling ability, upon a combustion gas of the rocket engine passing through the throat part, a cooling channel piping for guiding the oxidizer from the oxidizer storage part to the cooling channel, by which the oxidizer expresses an oxidization ability, and
   an oxidizer piping for supplying the oxidizer, which passes through the cooling channel into an oxidizer injection part and is then the oxidizer being expressed an oxidization ability.

The tenth aspect relates to
the regenerative cooling system for a rocket engine described in the ninth aspect, and the first member is characterized in that
   the helical groove part provided at a position corresponding to the throat part of the nozzle part,
   the position being a part of the inner circumferential surface of the first member,
   upon forming a helical cooling channel by forming a tube part corresponding to the helical groove part shape between the helical groove part and the second member,
   the helical cooling channel is formed at the position spaced the predetermined distance (ds) from the throat part formed inside of the second member,
   an effective width of the helical cooling channel (hw) is shorter than the total length of the nozzle part.

The eleventh aspect relates to
the regenerative cooling system for a rocket engine described in the tenth aspect, wherein,
   the second member is made of a predetermined thermal conductive material, including graphite, whereby
      upon a combustion gas of the rocket engine passing through the nozzle part, transferring heat received at the nozzle part of the second member to a coolant running through the helical cooling channel via the predetermined thermal conductive material, then
      demonstrating a predetermined cooling ability against the nozzle part by a heat-exchanging function of the coolant,
   the helical cooling channel is formed at the position spaced the predetermined distance (ds) from the throat part of the nozzle part formed inside of the second member,
   providing a device for decreasing a temperature gradually depending on the distance from the nozzle part, which is a heat-source, by using the predetermined thermal conductive material, and then
   upon the combustion gas of the rocket engine passing through the nozzle part, preventing the coolant running in the helical cooling channel from being excessively heated.

The twelfth aspect relates to
the regenerative cooling system for a rocket engine described in the tenth aspect, wherein,
   upon using nitrous oxide as the coolant running in the helical cooling channel,
   for the sake of preventing the combustion gas of the rocket engine from suddenly heating the nitrous oxide as the coolant and causing an explosive phenomenon, thereby the helical cooling channel or the nozzle part being destroyed,
   forming the helical cooling channel at a position spaced the predetermined distance (ds) from the throat part of the nozzle part formed inside of the second member, and
   the effective width of the helical cooling channel is shorter than the total length of the nozzle throat.

The thirteenth aspect relates to
the regenerative cooling system for a rocket engine described in the tenth aspect, wherein,
   the predetermined distance (ds) provided between the helical cooling channel and the throat part of the nozzle part is at least twice the diameter of the second member (nzd), and
   the effective width of the helical cooling channel (hw) with a width of one-third to one-half with respect to the total length of the second member (nzl).

The fourteenth aspect relates to
the regenerative cooling system for a rocket engine described in the tenth aspect, and the first member is characterized in that
   the helical groove part is provided at the position corresponding to the throat part of the nozzle part, the position being a part of the inner circumferential surface of the first member, and
   upon forming the tube part corresponding to the helical groove part shape between the helical groove part and the second member, thereby forming the helical cooling channel,
   the helical groove part having a swirl angle α of 2 to 10 degrees.

The fifteenth aspect relates to
the regenerative cooling system for a rocket engine described in the tenth aspect, and the first member is characterized in that
   the helical groove part is provided at the position corresponding to the throat part of the nozzle part, the position being a part of the inner circumferential surface of the first member, and
   upon forming the tube part corresponding to the helical groove part shape between the helical groove part and the second member,
   the number of channels of the helical groove part is 2 to 8.

The sixteenth aspect relates to
the regenerative cooling system for a rocket engine described in the fifteenth aspect, and the first member is characterized in that
   an introduction zone for introducing a coolant into the cooling channel is provided on a portion of the inner circumferential surface thereon,
   a recovery zone for recovering the coolant having elevated temperature due to running through the cooling channel is provided, and thereby
   even when the number of cooling channels I is as small as 2 to 8, allowing smooth introduction and recovery of the coolant to the cooling channels.

The seventeenth aspect relates to
the regenerative cooling system for a rocket engine described in any one of the ninth to sixteenth aspects, wherein,
   a phase change orifice is arranged at the cooling channel piping extending from the oxidizer storage part to the cooling channel, by which the oxidizer stored in the oxidizer storage part is vaporized from a liquid phase to a gas phase, and then delivered into the helical cooling channel.

### Advantageous Effects of Invention

The present disclosure relates to providing a highly safe cooling system free from explosive phenomena, even when nitrous oxide is used as an oxidizer for a hybrid rocket engine.

The present disclosure also indicates the possibility of suppressing nozzle erosion while balancing the cooling ability and the coolant's temperature rise.

### BRIEF DESCRIPTION OF THE DRAWINGS

FIG. 1 is a diagram showing an example of conventional technology.

FIG. 2 is a diagram showing an example of conventional technology.

FIG. 3 is a plane view showing an exemplary configuration of a first member of the present disclosure.

FIG. 4 is a front view showing an exemplary configuration of a first member of the present disclosure.

FIG. 5 is a perspective view of a B-B cross-section, showing an exemplary configuration of a first member of the present disclosure. The thick white open arrow indicates cold coolant, and the thick gray arrow indicates when heated after conducting cooling.

FIG. 6 is a B-B cross-section view, showing an exemplary configuration of a first member of the present disclosure.

FIG. 7 is an A-A cross-section view showing an exemplary configuration of a first member of the present disclosure.

FIG. 8 is a diagram showing an exemplary configuration of a first member of the present disclosure, in which (1) is a perspective view and (2) is a front view.

FIG. 9 is a diagram showing an exemplary configuration of a second member of the present disclosure, in which (1) is a C-C cross-section view, and (2) is a right-side view.

FIG. 10 is a diagram showing an exemplary configuration of a second member of the present disclosure, in which (1) is a left-side view and (2) is a D-D cross-section view.

FIG. 11 is a diagram showing an exemplary configuration that fits a first member and a second member of the present disclosure.

FIG. 12 is a perspective view of an exemplary nozzle cooling device formed by combining a first member and a second member of the present disclosure.

FIG. 13 is a perspective view of the B-B cross-section, showing an exemplary nozzle cooling device formed by combining the first member and the second member of the present disclosure.

FIG. 14 is an enlarged view (perspective view) showing an example of a B-B cross-section of cooling channels formed by flush engaging a helical groove part and protrusion part of a first member with the outer peripheral surface of a second member of the present disclosure.

FIG. 15 is a B-B cross-sectional view showing an exemplary nozzle cooling device formed by combining a first member and a second member of the present disclosure.

FIG. 16 is a diagram showing an exemplary nozzle cooling device formed by combining a first member and a second member of the present disclosure, including an overview of coolant flow.

FIG. 17 is a diagram in which the second member in FIG. 16 is made transparent to visualize the flow of the coolant therein.

FIG. 18 is an enlarged view of the “cooling channel inlet” (dotted line portion) in FIG. 17, showing helical cooling channels configured with a helical groove part and a protrusion part. It also shows an example of how coolant flows in each cooling channel upon the number of cooling channels is three.

FIG. 19 is an enlarged view of the “cooling channel inlet” (dotted line portion) in FIG. 17, showing a helical cooling channel configured with a helical groove part and a protrusion part. It also shows an example of how coolant flows in each cooling channel in the case that the number of cooling channels is two.

FIG. 20 is a diagram showing an example of differences in the configuration of cooling channels due to the difference in the number of cooling channels.

FIG. 21 is a B-B cross-sectional perspective view showing an exemplary cooling device formed by combining a first member and a second member of the present disclosure. It shows a modified example in which the second member has a two-piece structure.

FIG. 22 is a B-B cross-section view showing an exemplary cooling device formed by combining a first member and a second member of the present disclosure. It shows a modified example in which the second member has a two-piece structure.

FIG. 23 is a diagram showing an exemplary configuration of a second member of the present disclosure. It shows a modified example in which the second member has a two-piece structure.

FIG. 24 is a diagram showing an exemplary configuration of a first member of the present disclosure. It is a B-B cross-sectional perspective view of a modified example in which the inner circumferential surface of the first member has a tapered shape that is wide at the inlet and narrows toward the outlet.

FIG. 25 is a diagram showing an exemplary configuration of a first member of the present disclosure. It is a B-B cross-section view of a modified example in which the inner circumferential surface of the first member has a tapered shape that is wide at the inlet and narrows toward the outlet.

FIG. 26 is a diagram showing an exemplary configuration of a second member of the present disclosure. It shows a modified example in which the outer circumferential surface of the second member has a tapered shape that is wide at the inlet and narrows toward the outlet. (1) is a C-C cross-section view, and (2) is a perspective view.

FIG. 27 is a diagram showing an exemplary cooling device formed by combining a first member and a second member of the present disclosure. It is a B-B cross-section view of an exemplary configuration formed by combining a first member and a second member, in case the first member has an inner circumferential surface of a tapered shape that is wide at the inlet and narrows toward the outlet, and the second member has an outer circumferential surface of a tapered shape that is wide at the inlet and narrows toward the outlet.

FIG. 28 is a diagram showing an exemplary configuration of the first member of the present disclosure: this is a B-B cross-sectional perspective view of a modified example in which the inner circumferential surface of the first member has a tapered shape that is narrow at the inlet.

FIG. 29 is a diagram showing an exemplary configuration of a first member of the present disclosure. It is a B-B cross-section view of a modified example in which the inner circumferential surface of a first member has a tapered shape that is narrow at the inlet and changing wider toward the outlet.

FIG. 30 is a diagram showing an exemplary configuration of a second member of the present disclosure. It shows a modified example in which the outer circumferential surface of the second member has a tapered shape that is wide at the inlet and narrows toward the outlet. (1) is a C-C cross-section view, and (2) is a perspective view.

FIG. 31 is a diagram showing an example of using a nozzle cooling device formed by combining a first member and a second member of the present disclosure. It is a perspective view of an exemplary configuration upon combining the cooling device with a hybrid rocket engine body.

FIG. 32 is a diagram showing an example of using a nozzle cooling device formed by combining a first member and a second member of the present disclosure. It is a plane view of an exemplary configuration upon combining the cooling device with a hybrid rocket engine body.

FIG. 33 is a diagram showing an example of using a nozzle cooling device formed by combining a first member and a second member of the present disclosure. It is a cross-section view of an exemplary configuration upon combining the cooling device with a hybrid rocket engine body.

FIG. 34 is a diagram showing an example of using a nozzle cooling device formed by combining a first member and a second member of the present disclosure. It is a perspective view of an exemplary regenerative cooling system configuration, including coolant and oxidizer piping, upon combining the cooling device with a hybrid rocket engine body.

FIG. 35 is a diagram showing an example of using a nozzle cooling device formed by combining a first member and a second member of the present disclosure. It shows an exemplary regenerative cooling system configuration, including coolant and oxidizer piping and a phase change orifice arrangement, upon combining the cooling device with a hybrid rocket engine body.

FIG. 36 is a diagram showing an example of using a nozzle cooling device formed by combining a first member and a second member of the present disclosure. It shows an exemplary regenerative cooling system configuration, including coolant and oxidizer piping and a phase change orifice arrangement, upon combining the cooling device with a hybrid rocket engine body.

FIG. 37 is a diagram showing the difference in the configuration of helical cooling channels depending on the number of channels of cooling channels, in which (1) shows the case where the number of channels is a predetermined number, and (2) shows the case where the number of channels is increased compared to (1).

FIG. 38 is a diagram showing the relationship between the number of channels n and a swirl angle α in the case of helical cooling channels.

FIG. 39 is a diagram showing the difference between the helical cooling channel case and the axial cooling channel case. It shows the change trends of pressure drop and Nusselt number.

FIG. 40 is a diagram showing calculation formulas for the configuration of helical cooling channels.

FIG. 41 is a diagram showing a comparison of nozzle wall temperature, liquid heat transfer coefficient, and pressure drop when the number of channels n is changed.

FIG. 42 is a diagram showing the cooling ability when graphite is used for a nozzle material.

FIG. 43 is a diagram showing the difference in characteristics between liquid oxygen and liquid nitrous oxide.

FIG. 44 is a diagram showing the experimental conditions and the states of the nozzle (throat part) after the experiments. (1) is a table showing the experimental conditions, (2) shows the states of the nozzle (throat part) after tests 1 to 4, and (3) shows the state of the nozzle (throat part) after test NC (without cooling).

FIG. 45 is a diagram showing the performance of a cooling device and a regenerative cooling system according to the present disclosure: (1) shows chamber pressures of the coolant tank and the pressures measured upstream and downstream of the regenerative cooling system during the experiments, and (2) shows the temperatures measured upstream and downstream of the cooling system.

FIG. 46 is a diagram showing the performance of a cooling device and a regenerative cooling system according to the present disclosure during the experiments: (1) shows the distance from the nozzle and the temperatures, and (2) shows the thrust of the rocket engine during the experiment to check that constant propellant injection was maintained.

FIG. 47 is a diagram for exploring the performance of a cooling device and a regenerative cooling system of the present disclosure. (1) shows the temperatures (distance from the nozzle and temperature) avoiding the employment of a cooling system, while (2) shows the cooling effect (distance from the nozzle and temperature) of the cooling system of the present disclosure under the same conditions.

FIG. 48 is a diagram for exploring the performance of a cooling device and a regenerative cooling system of the present disclosure. It shows pressures recorded downstream of the cavitation point and inside the chamber, avoiding the employment of a cooling device.

FIG. 49 is a diagram showing the performance of a cooling device and a regenerative cooling system of the present disclosure. (1) shows the chamber pressures of a coolant tank. (2) shows the temperatures at a distance of 12 mm from the nozzle.

FIG. 50 is a diagram showing the positional relationship between cooling channels and a throat part, and an effective width with respect to the total length (when the second member is cylindrical).

FIG. 51 is a diagram showing the positional relationship between cooling channels and a throat part, and an effective width with respect to the total length (when the second member is tapered).

### DETAILED DESCRIPTION OF THE PREFERRED EMBODIMENTS

It is advantageous to define several terms before describing the invention. It should be appreciated that the following definitions are used throughout this application.

### Definitions

A nozzle is a structure located immediately after a rocket engine's combustion chamber. Its function is to exhaust combustion gases from the rocket. Providing the nozzle with a predesignated shape on its inner circumferential surface can increase the pressure in the combustion chamber or the injection speed of the exhausted combustion gas. For instance, a Laval nozzle with a narrower portion in the middle of its tube, like an hourglass, is known to accelerate the combustion gas up to supersonic speed.
A nozzle part refers to a part of the inner circumferential surface of a nozzle. When it is a metal nozzle, it usually has the same shape as the nozzle itself, so a nozzle and a nozzle part are essentially the same. On the other hand, when it is graphite, the nozzle is usually cylindrical or tapered in shape, and the inner circumferential surface forms a cavity having a predetermined shape to function as a nozzle. In that case, the outline on the inner circumferential surface is defined as a nozzle part.
A throat is the narrowest region of the nozzle, which increases the pressure inside the combustion chamber. In addition, due to the narrowed diameter, the flow velocity of the injected combustion gases increases, thereby improving the thrust. The throat part diameter, relative to nozzle part inlet and outlet diameters, is an important parameter that determines the thrust of a rocket engine. The throat part is also the region most exposed to high temperatures and pressures in a nozzle part. The thrust may be reduced if this part erodes and its opening widens. Therefore, preventing a throat part from erosion is an important issue.
Self-pressurization is pressurization due to a simple process of discharging propellant from a tank without using complex pumps and pressurization systems, which are typically required. Nitrous oxide (N2O) has a high vapor pressure at room temperature (approximately 50 bar), making self-pressurization possible.
Oxidizers have a function to burn fuel in an oxygen-free space. All of the rockets, liquid fuel rockets, solid fuel rockets, and hybrid rockets use oxidizers. Attempts have been made to use liquid oxygen (LO2) and liquid nitrous oxide (N2O).
Hybrid rocket engines are rocket engines that use solid fuel and liquid oxidizers.
Regenerative cooling refers to a method of cooling that utilizes the latent heat of vaporization. It is adopted in rocket engines, refrigerating machines, or refrigeration systems. In the case of liquid-fuel rocket engines, fuel is used for cooling. In hybrid rocket engines, an oxidizer is used for cooling.
Helical means a helix shape, and “spiral” is a synonym. Both spiral and helical are translated into the Japanese language as “rasen,” but a spiral can be distinguished as a vortex with a center point, while a helical can be distinguished as a coil shape.
A cooling channel is a tube through which a coolant passes. According to the present disclosure, the tube can be formed from a pipe or a combination of a curved or flat surface and a groove.
A helical cooling channel has a structure configured with an outside first member and an inside second member. The inner circumferential surface of the first member has a helical groove part. The structure passes coolant by making the inner circumferential surface of the first member, which is the same surface as the propositions of the helical groove part, and the outer circumferential surface of the second member flush.
An introduction zone is a zonal space where the coolant is pooled and introduced to each cooling channel inlet. Its structure is configured with an outside first member and an inside second member. The inner circumferential surface of the first member has a groove part. It is configured by making the inner circumferential surface of the first member, without the groove part, and the outer circumferential surface of the second member flush. Unlike the helical cooling channels, the introduction zone has an annular structure without twists. Furthermore, it is desirable to be wider than the helical groove part, which provides the cooling channel, to temporarily pool coolant and introduce it to each cooling channel inlet.
A recovery zone is a zonal space where the coolant that has already been used and heated is recovered from each coolant channel outlet. Its structure is the same as an introduction zone, so the descriptions are omitted.
Nusselt number (Nu) is a dimensionless number representing the thermal conduction and heat transfer ratio of a convection fluid. When there is no convection, Nu=1. The Nusselt number is used to evaluate a heat transfer performance (heat dissipation performance, etc.) due to convection. The higher the Nusselt number, the higher the heat transport effect due to convection.
Cavitation is a state in which liquid has been turned into bubbles by an orifice.
O2 means oxygen.
LO2 means liquid oxygen.
N2O means nitrous oxide.
LN2O means liquid nitrous oxide.
HDPE is an abbreviation for high-density polyethylene and is used as solid fuel in hybrid rocket engines.
Equivalence ratio is the ratio of the mass flow rate of the oxidizer “om” to the mass flow rate of the fuel “fm” (om/fm).

### Descriptions

Embodiments of the present disclosure will be described below.

Note that the configurations, figures, and tables described are examples and may be applied to other shapes and configurations.

### 1. Respective Configurations of a First Member and a Second Member

### 1-1. Overview

The nozzle cooling device for a rocket engine of the present disclosure has two main components: a first member arranged on the outside and a second member arranged on the inside.

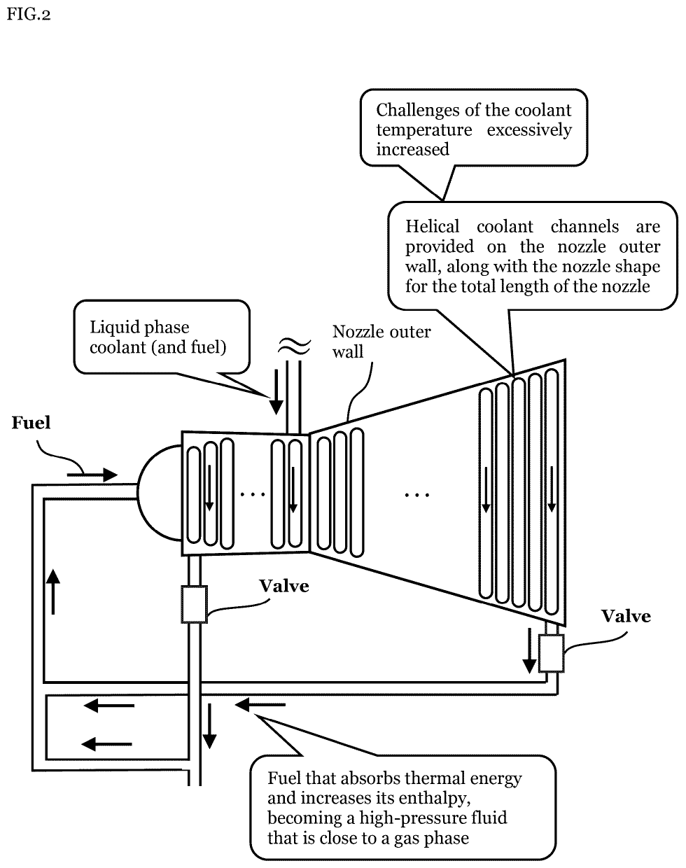

Hereinafter, we will first describe the configuration of the first member of the nozzle cooling device for a rocket engine of the present disclosure, referring to FIGS. 2 to 7.

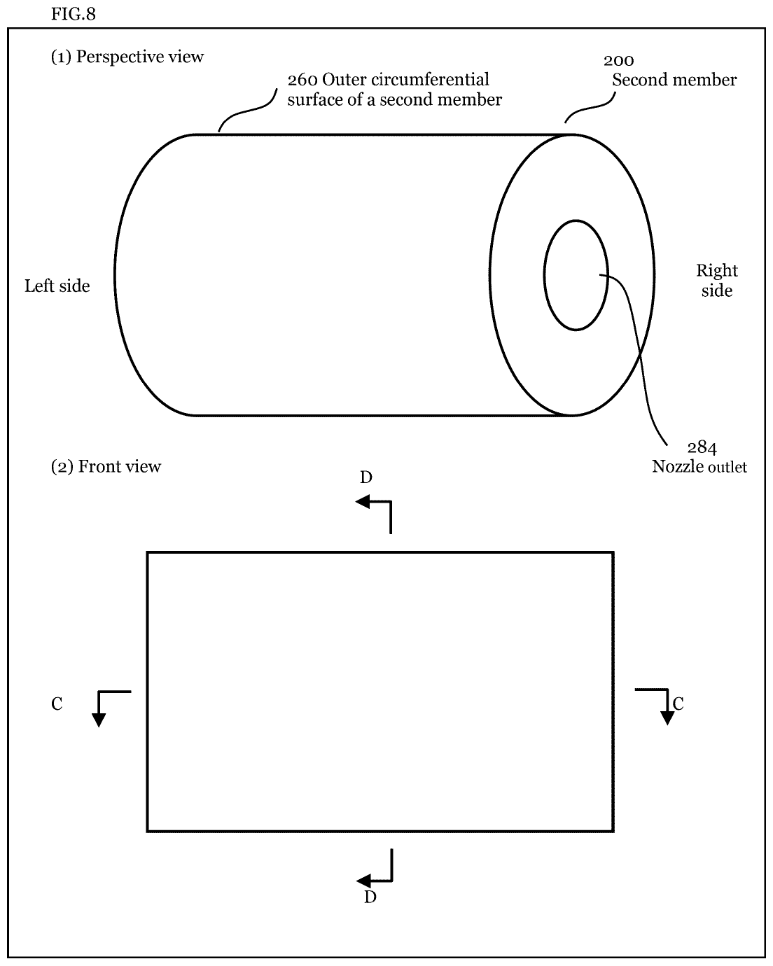

Next, we will describe the configuration of the second member, referring to FIGS. 8 to 10.

### 1-2. Configuration of a First Member

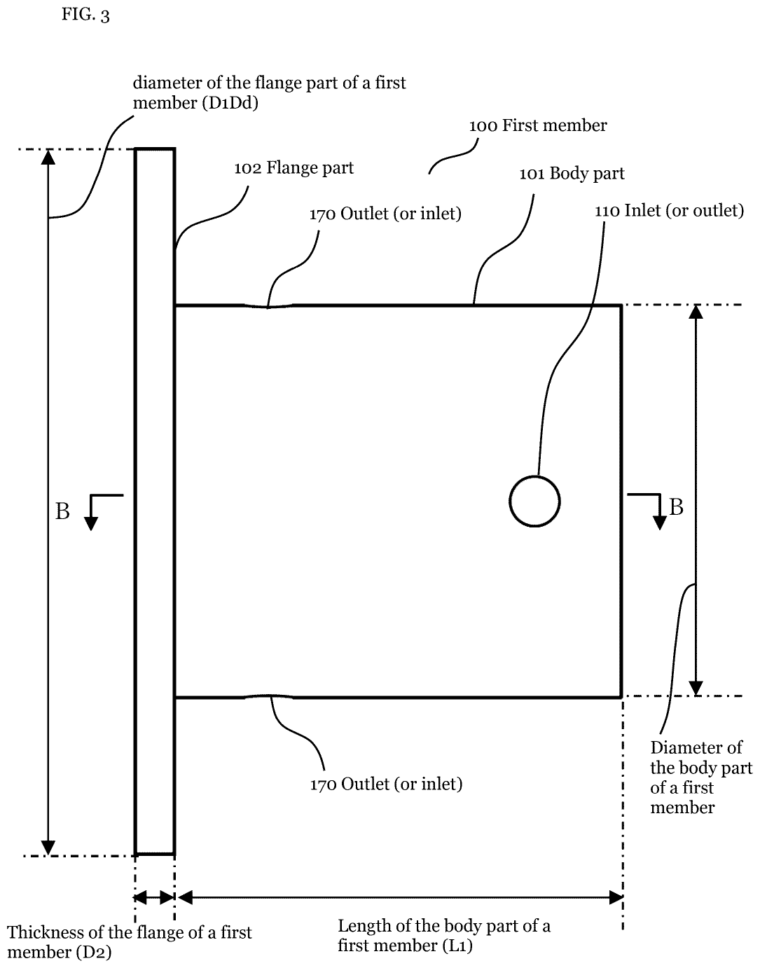

### 1-2-1. Configuration of the First Member (Plane View) (FIG. 3)

FIG. 3 is a diagram showing an exemplary configuration of a first member of the present disclosure. It is a plane view of a first member, and the viewpoint is above.

The first member is roughly configured by a cylindrical body part 101 and a disk-shaped flange part 102.

A flange part 102 has flanges connected to the hybrid rocket engine body.

Inlets 110 and outlets 170 are provided on the outer circumferential surface of a body part 110 to supply and exhaust coolant (oxidizer).

FIG. 3 indicates that the inlets 110 and the outlets 170 are positioned at positions offset by 90 degrees from each other, but they may be provided facing in the same direction.

For instance, they may be arranged freely depending on coolant piping convenience.

Also, the positions of inlets and outlets may be reversed.

For this reason, in FIG. 3 and subsequent figures, they are expressed as inlet (or outlet) or outlet (or inlet).

In addition, whereas FIG. 3 shows one inlet 110 and two outlets 170, the numbers may be freely provided as one or two, respectively.

The dimensions setting of each part may be free depending on the size and output of rockets. For instance, if the total length, including a hybrid rocket engine body, is approximately 30 cm, available provisions are like this: the diameter of a body part of the first member (D1Dd) is approximately 5 cm, the length of the body part of a first member (L1) is approximately 6 cm, the diameter of the flange part of a first member (D1Fd) is approximately 9 cm, and the thickness of the flange part of a first member (D2) is approximately 5 mm.

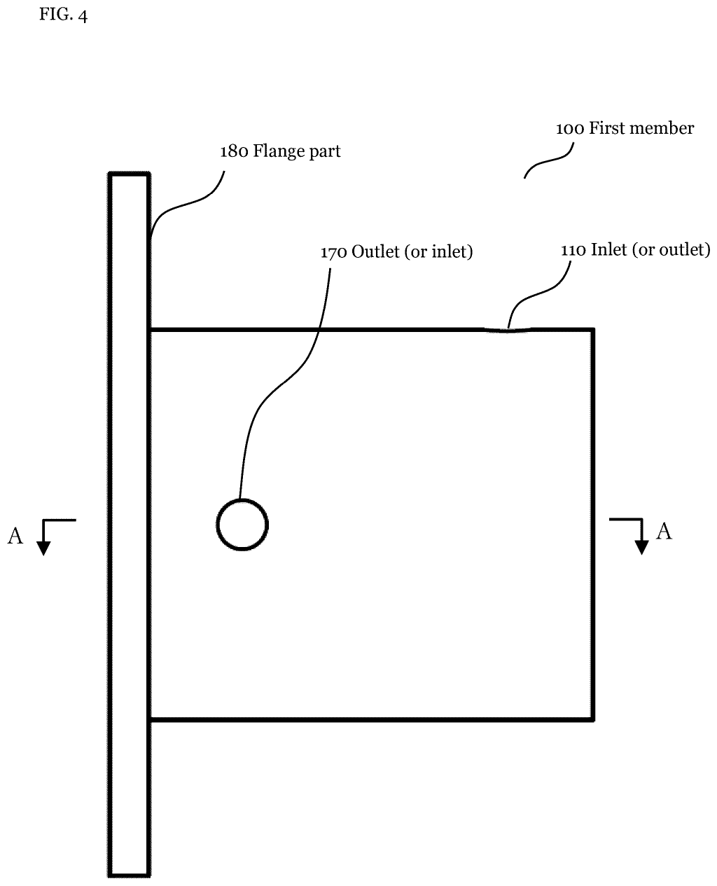

### 1-2-2. Configuration of a First Member (Front View) (FIG. 4)

FIG. 4 is a front view of a first member showing an exemplary configuration of the first member of the present disclosure.

Its rear view is subsequently the same, so a description of the rear view is omitted.

The positional relationship between inlets 110 and outlets 170 and the numbers of them are the same as the descriptions in FIG. 3, so the descriptions are omitted.

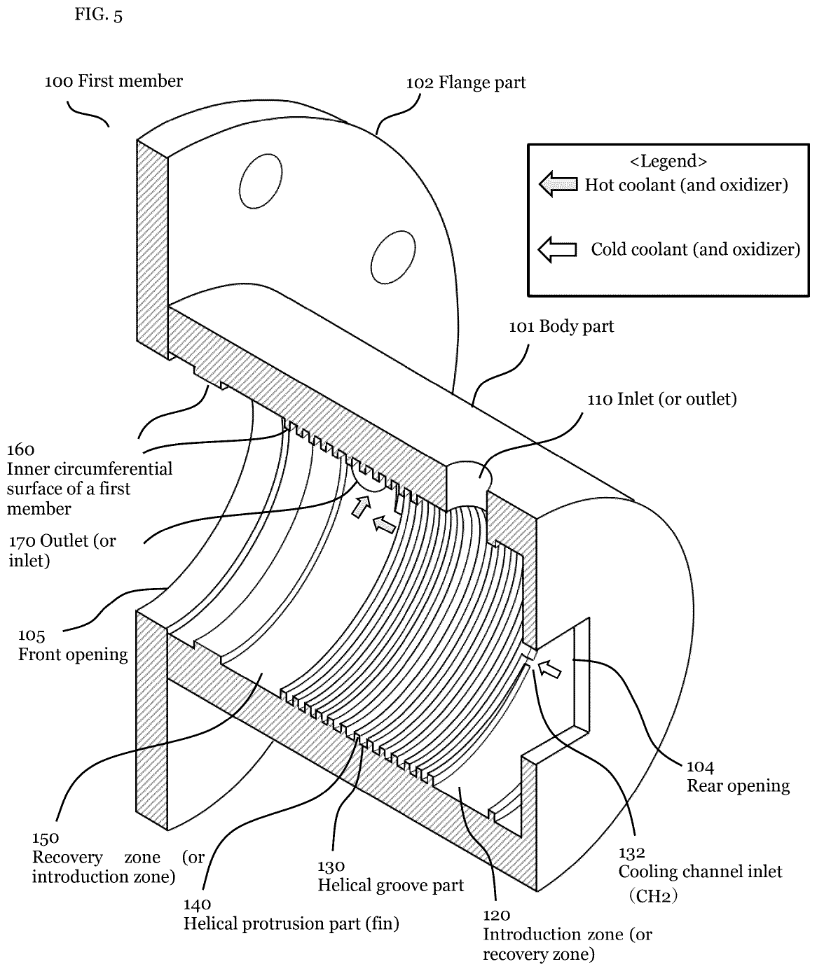

### 1-2-3. Configuration of a First Member (B-B Cross-Sectional Perspective View) (FIG. 5)

FIG. 5 is a perspective view of a B-B cross-section, showing an exemplary configuration of a first member of the present disclosure.

As shown in FIG. 5, the inner circumferential surface of a first member may be substantially cylindrical, or, as mentioned below, a configuration with a changing inner diameter, such as a tapered one, is also allowable.

In addition, FIG. 5 indicates that an inlet 110, used to supply coolant, is a through hole that penetrates from the outer circumference surface into the inner circumference surface of a first member.

An Outlet 170, used to exhaust coolant, is also a through hole that penetrates from the inner circumference surface into the outer circumference surface of a first member, while it is partly unshown.

A characteristic aspect of FIG. 5 is that the first member 100 equips a helical groove part 130 and helical protrusion (fin) part 140.

The helical groove part 130 may be shaped by machining the inner circumferential surface of a first member 160 or a high-precision 3D printing.

The helical protrusion (fin) part 140 is provided on the inner circumferential surface of the first member flush as a by-product of shaping the helical groove part 130.

A front opening 105 is an opening for inserting the second member described below.

A rear opening 104 is an opening for exhausting combustion gas from the injection port of a nozzle provided inside the second member. It is set to a size larger than the diameter of the nozzle of the second member.

In FIG. 5, the shape of the rear opening 104 is drawn as a rectangle, but it is not limited to this shape and can be freely selected from polygons such as a triangle or pentagon, a circle, or an ellipse.

The thick arrows in FIG. 5 indicate coolant flow. A thick white open arrow indicates a cold coolant flow, and thick gray arrows indicate a heated coolant due to heat exchange during a cooling process.

To provide a path in which coolant runs, the presence of grooves shaped on the inner circumferential surface of a first member is insufficient. A cooling channel is formed with a groove part of a first member and an outer circumferential surface of a second member by fitting the inner circumferential surface of the first member and the outer circumferential surface of a second member, as described below.

Therefore, note that the following description includes the coolant flow when forming a cooling channel.

The thick white arrow indicates a coolant flow: coolant is supplied from the inlet 100, enters the introduction zone 120, passes through the cooling channel inlet 132, and enters the helical groove part 130 (cooling channel).

After that, the heated coolant that has worked for nozzle cooling flows from the helical groove part 130 (coolant channels below precisely) into the recovery zone 150 and then into the outside of the first member via the outlet 170.

Also, the positions of the introduction zone and the recovery zone may be reversed, just like the inlet and outlet positions, which are exchangeable.

For this reason, they are expressed as introduction zone (or recovery zone) or recovery zone (or introduction zone) in FIG. 5 and subsequent figures.

Concepts of the number of channels will be described in detail later, but to briefly explain, refer to FIG. 5, “Cooling channel inlet (CH2)” indicates that a cooling channel is configured for each channel. The number of channels n may be set as an integer greater than or equal to one, but as will be described later, it is preferable to select a value within a predetermined range to ensure cooling ability and prevent coolant overheating.

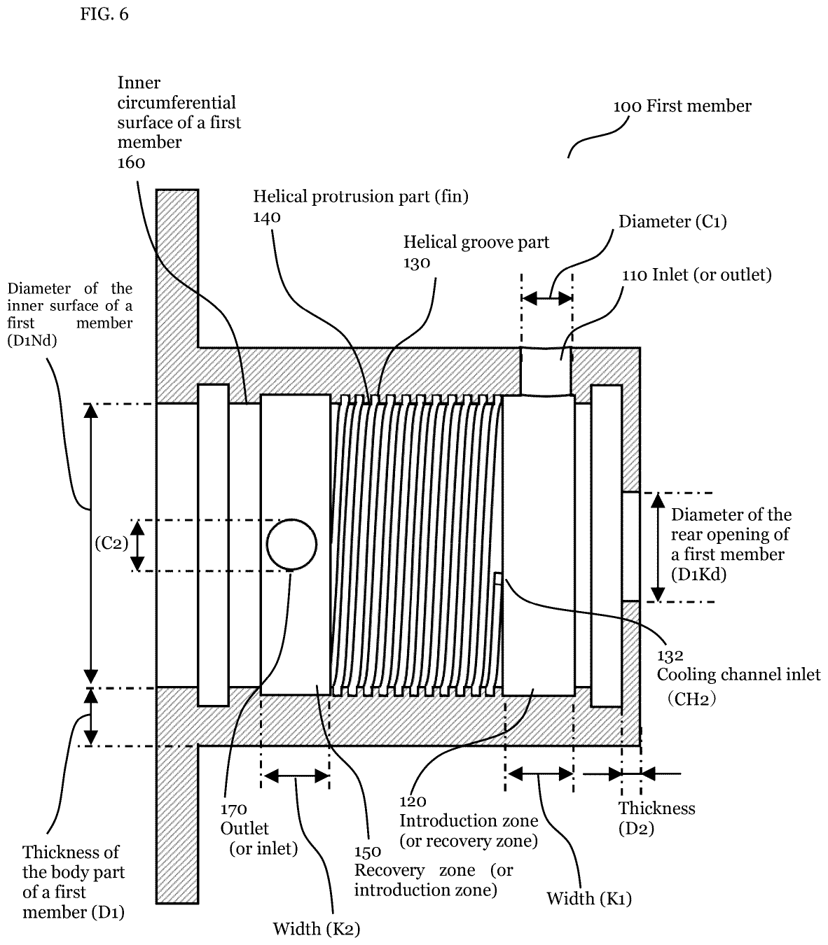

### 1-2-4. Configuration of a First Member (B-B Cross-Section View) (FIG. 6)

FIG. 6 is a B-B cross-section view, showing an exemplary configuration of a first member of the present disclosure.

The configuration of each section is the same as FIG. 5, so the description is omitted for duplicate contents.

The dimensions setting of each part may be free depending on the size and output of the rockets. For instance, if the total length of a first member is approximately 60 mm, diameters C1 and C2 of a coolant inlet 100 and a coolant outlet 170, respectively, are provided as approximately 5 mm.

Also, for instance, the width of an introduction zone (K1) and the width of a collect zone (K2) may be defined as approximately 9 mm, respectively; the diameter of the inner surface of a first member (D1Nd) may be defined as approximately 35 mm; and the diameter of the rear opening of a first member (D1Kd) may be defined as approximately 14 mm.

Also, for instance, the thickness of the body part of a first member (D1) may be defined as approximately 7 mm, and (D2) may be defined as approximately 3 mm.

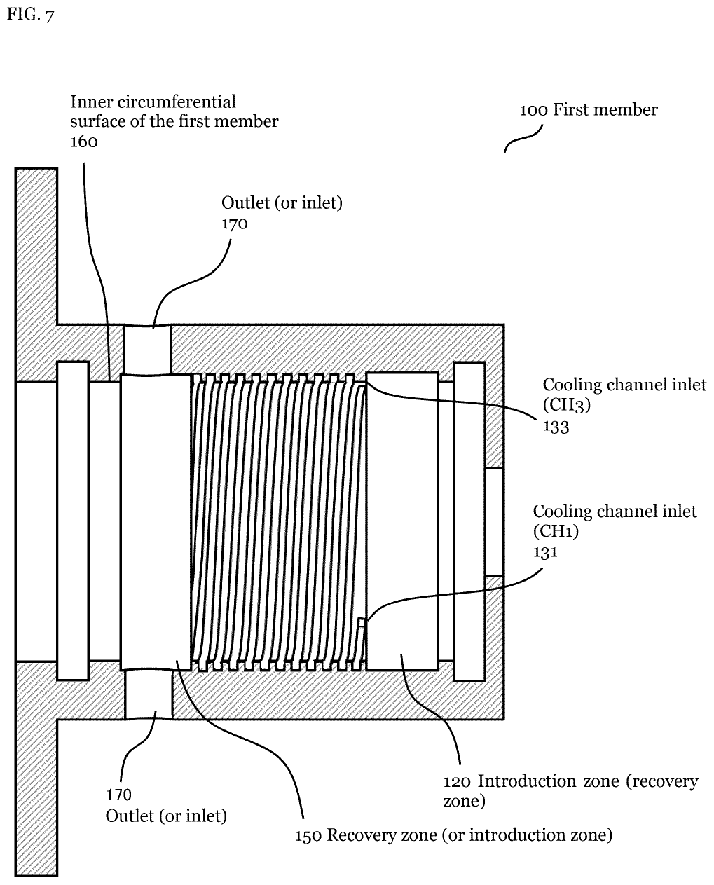

### 1-2-5. Configuration of a First Member (A-A Cross-Section View) (FIG. 7)

FIG. 7 is an A-A cross-section view showing an exemplary configuration of a first member of the present disclosure.

The configuration of each section is the same as FIGS. 5 and 6, so descriptions are omitted for duplicate contents.

As mentioned above, a cooling channel may be provided per channel, and the number of channels can optionally be set to an integer equal to or greater than one.

Therefore, FIG. 7 represents each channel as a cooling channel inlet (CH1) 131, and a cooling channel inlet (CH3) 133.

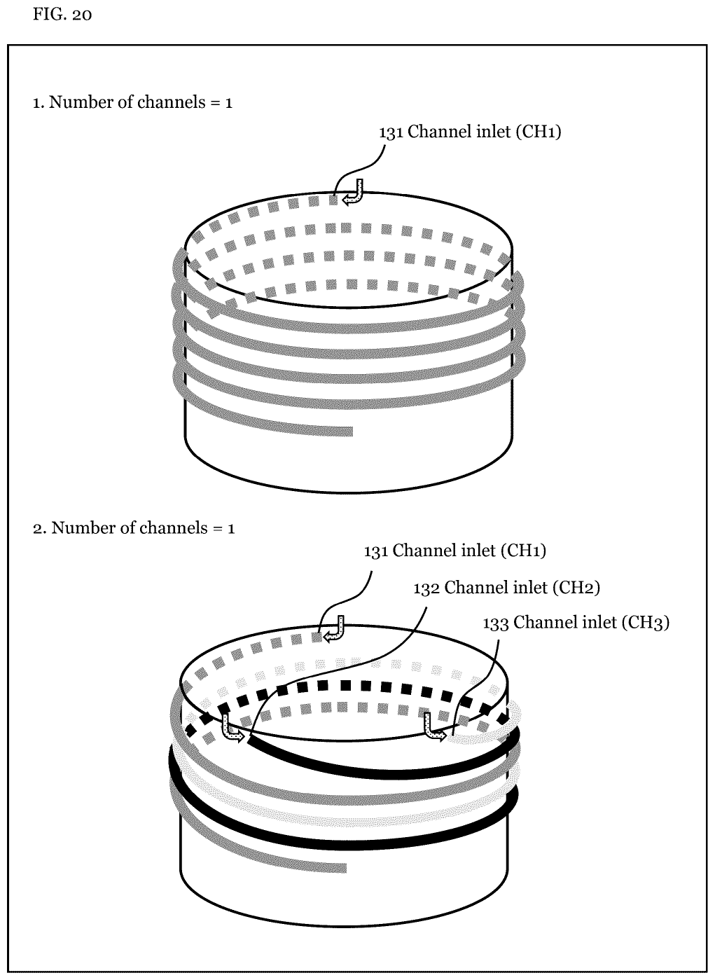

Cooling channel inlets are preferably evenly spaced. For instance, when the number of channels n=3 CH, they are arranged at equal intervals of 120 degrees (See FIG. 20(2)).

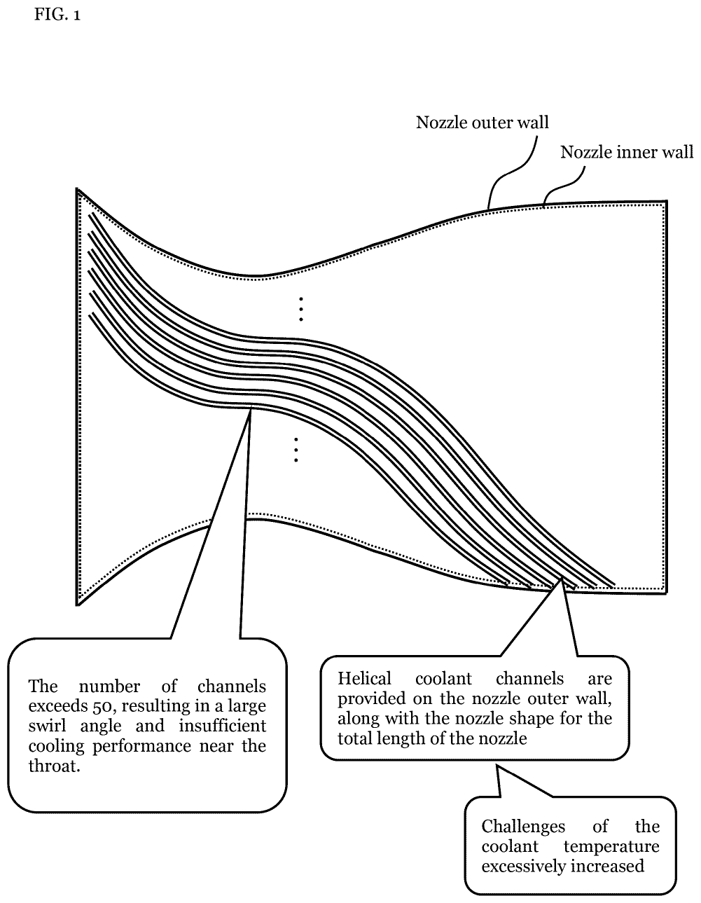

Concerning conventional arts, there is no description or indication relating to “Configuring coolant channels per channel and tuning the number of channels has the benefit of contributing to cooling ability and preventing overheat of coolant” (See Patent Document 1, Patent Document 2, and FIGS. 1 and 2 of the present disclosure).

### 1-3. Configuration of a Second Member

### 1-3-1. Configuration of a Second Member (Perspective View and Front View) (FIG. 8)

FIG. 8 is a diagram showing an exemplary configuration of a first member of the present disclosure, in which (1) is a perspective view and (2) is a front view.

A second member has a smooth outer circumferential surface 260 and is used to form cooling channels where coolant runs inside. The cooling channels are formed by inserting the second member into the inside of a first member and fitting flush the inner circumferential surface of the first member 160 and the outer circumferential surface of the second member 260.

FIG. 8(1) indicates the outer circumferential surface of a second member 260, which has substantially the same shape (cylindrical shape) as the inner circumferential surface of the first member 160.

It also indicates that a nozzle part for running the rocket engine's high-temperature combustion gas may be provided inside the second member. FIG. 8(1) shows a nozzle outlet 284.

FIG. 8(2) indicates that when a second member's shape is substantially cylindrical, its front view is substantially rectangular.

Therefore, the plane view, rear view, and bottom view are omitted since they all have the same shape.

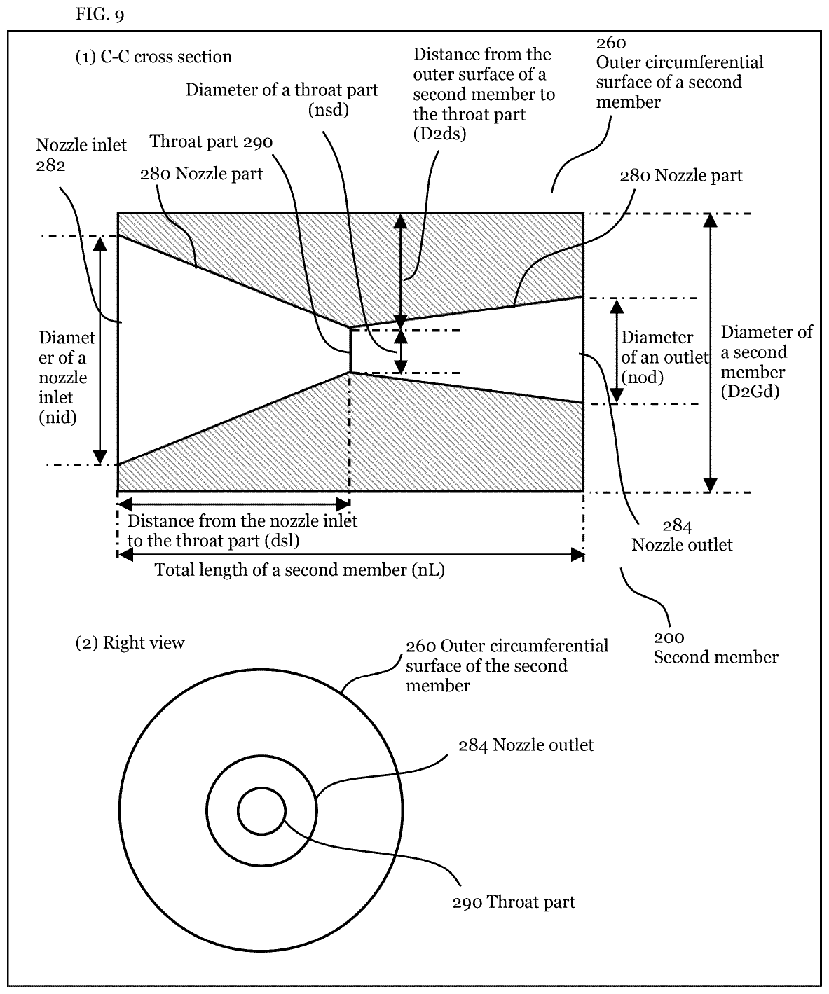

### 1-3-2. Configuration of the Second Member (Cross-Section View and Right Side View) (FIG. 9)

FIG. 9 is a diagram showing an exemplary configuration of a second member of the present disclosure, in which (1) is a C-C cross-section view, and (2) is a right-side view.

FIG. 9(1) shows an exemplary configuration in which a nozzle part 280 is provided inside a second member.

In general, the adapted nozzle's inside shape is tapered and has a circular cross-section.

The diameter of a nozzle inlet (nid) 282, is narrower than the diameter of a throat part (nsd) 290. That configuration effectively increases the pressure inside a combustion chamber. In addition, due to the narrowed diameter, the flow velocity of the injected combustion gases increases, thereby improving the thrust.

The dimensions setting of each part may be free depending on the size and output of rockets. For instance, if the total length of a second member (nL) is approximately 60 mm and the diameter is approximately 35 mm, available provisions are: the diameter of an inlet (nid) is from 10 to 30 mm, the diameter of a throat part (nsd) is from 5 to 8 mm, and the diameter of an outlet is from 10 to 30 mm.

For instance, the distance from an inlet to a throat part (dsl) may be 25 to 30 mm, the distance from an outer circumferential surface of the second member 260 to a throat part 290 (D2ds) may be 10 to 15 mm.

Here, it is indicated that the distance from the outer circumferential surface of a second member 260 to the throat part 290 (D2ds) is almost the same as the distance from the cooling channel to the throat part 290.

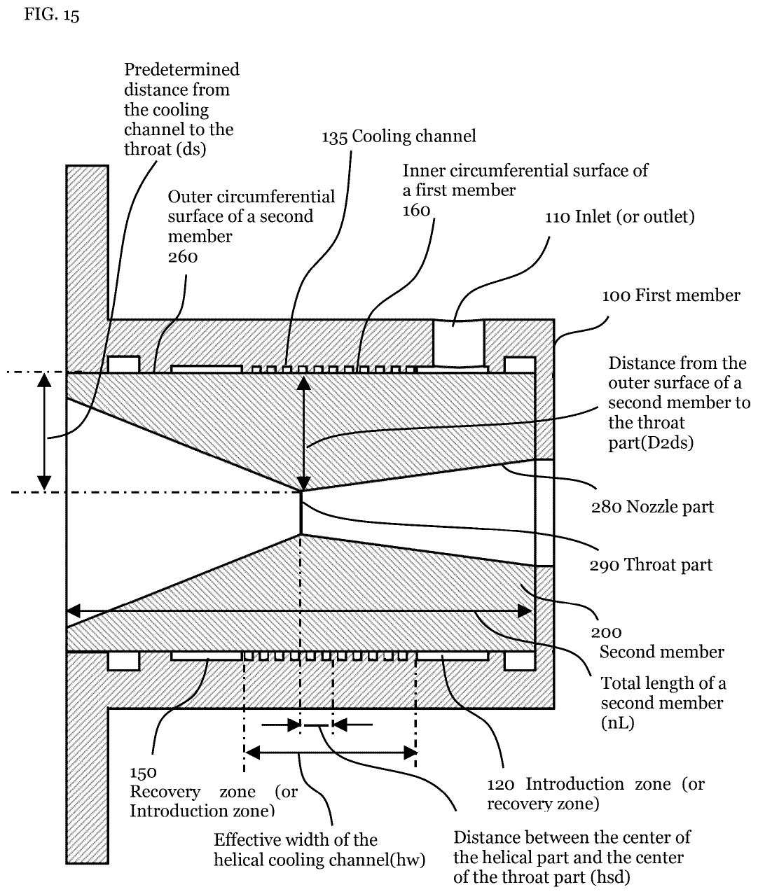

As described in detail later, the distance from the outer circumferential surface of a second member 260 to the throat part 290 (D2ds) and the distance from a cooling channel to the throat part 290 (ds) (not shown in FIG. 9 and see FIG. 15) are important parameters for balancing the cooling ability of the nozzle part and preventing the coolant from being overheated, considering the thermal conductivity of a second member material.

FIG. 9(2) is a right-side view of a second member and shows the shape of an outer circumferential surface of the second member (substantially circle) and the shape of the throat part 290, located at the back (substantially circle).

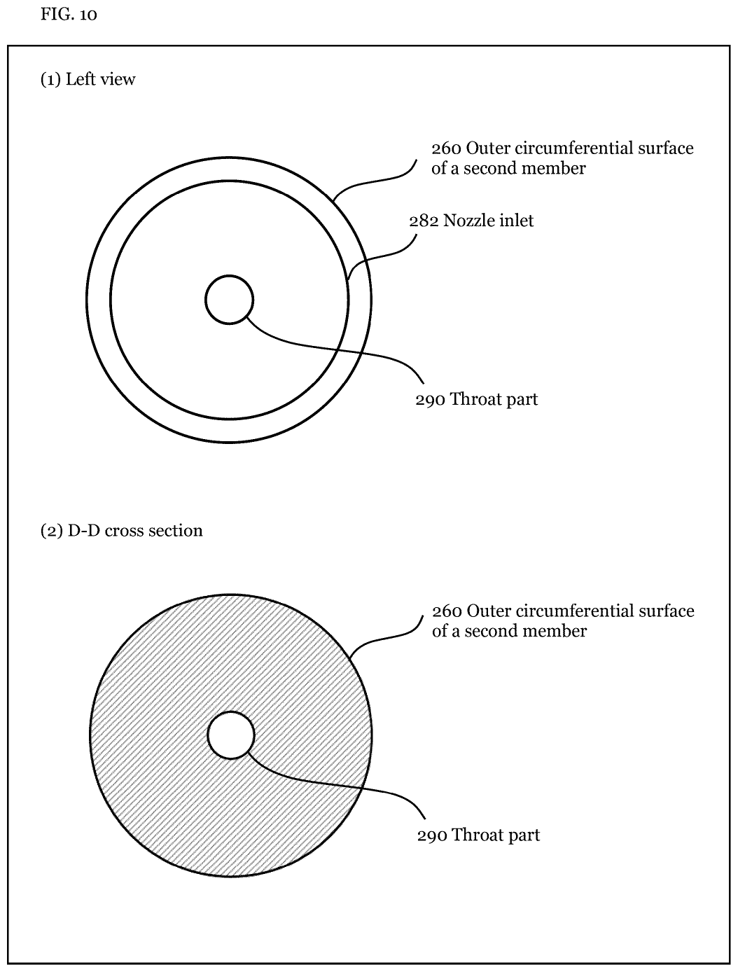

### 1-3-3. Configurations of a Second Member (Left-Side View and Cross-Section View) (FIG. 10)

FIG. 10 is a diagram showing an exemplary configuration of a second member of the present disclosure, in which (1) is a left-side view and (2) is a D-D cross-section view.

FIG. 10 shows a nozzle inlet 282, a throat part 290, and the shape of an outer circumferential surface of the second member.

2. Configurations of a First Member and a Second Member when Combined

### 2-1. Overview

We have described a first member and a second member above, respectively. Next, we will describe a nozzle cooling device of the present disclosure for a rocket engine when both are combined.

2-2. Fitting of a First Member with a Second Member

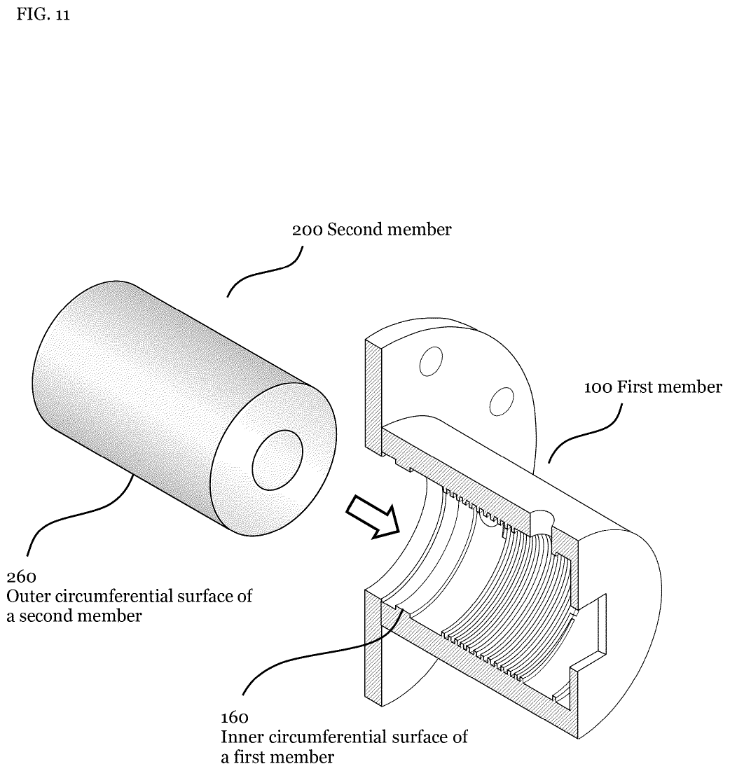

FIG. 11 is a diagram showing an exemplary configuration that fits a first member with a second member of the present disclosure.

Upon setting the diameter of the inner surface of a first member (D1Nd) and the diameter of the outer surface of a second member (D2Gd) are substantially the same, both can fit flush.

In practice, considering the operability of fitting, the desirable setting is that the diameter of the inner surface of a first member (D1Nd) is slightly bigger than that of the outer circumferential surface of a second member (D2Gd) in microns.

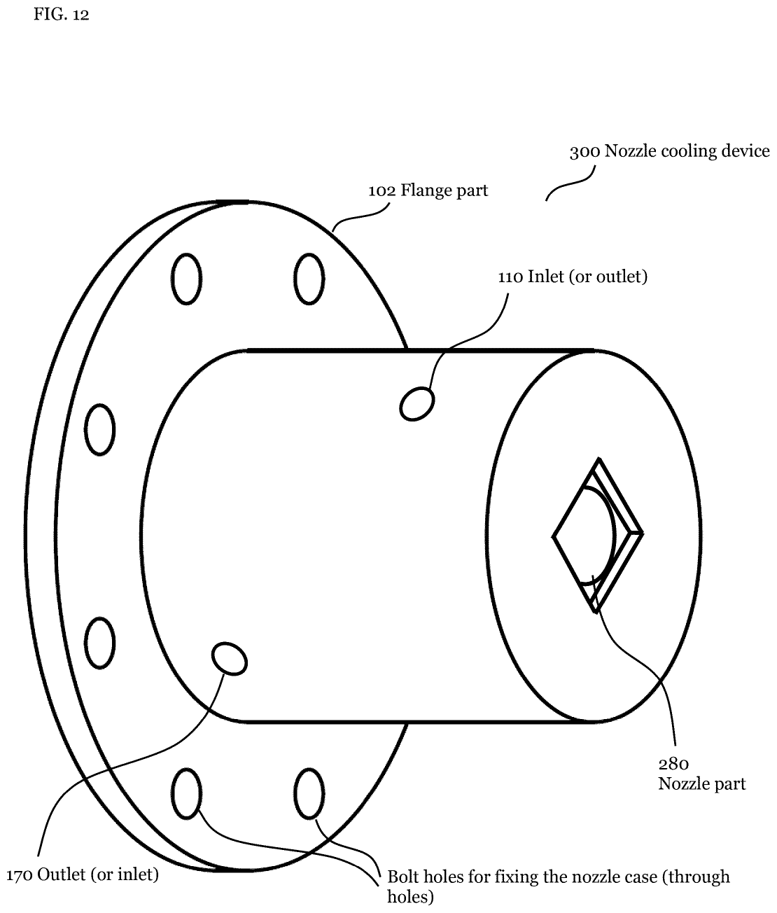

2-3. Appearance when a First Member and a Second Member are Combined (FIG. 12)

FIG. 12 is a perspective view of an exemplary nozzle cooling device formed by combining a first member and a second member of the present disclosure.

FIG. 12 shows an exemplary positional relationship between an inlet 110 and an outlet 170 for coolant.

In addition, it shows the condition where the shape of the nozzle outlet 284 of the nozzle part arranged inside the second member is viewed from the rear opening 104 of the first member.

The flange part 102 may have a hole (through hole) to fix the nozzle case with a bolt.

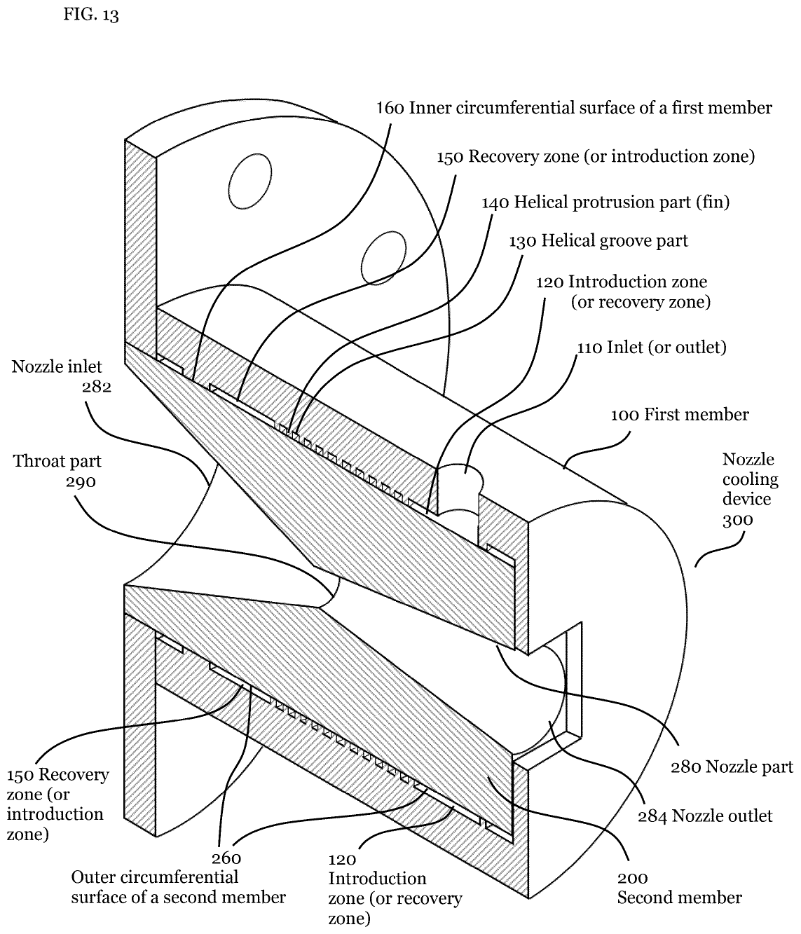

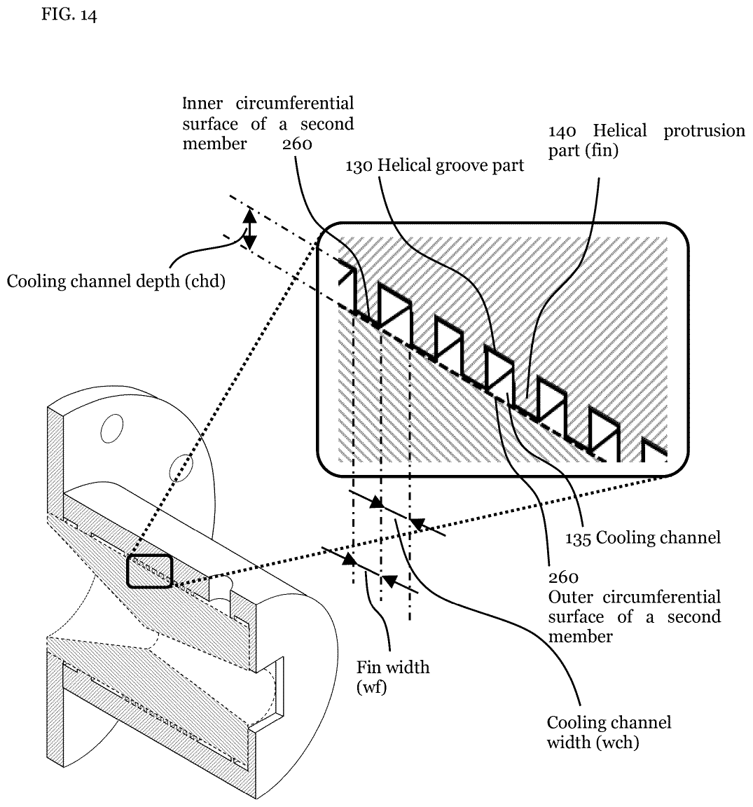

2-4. Inner Configurations when a First Member and a Second Member are Combined (Cross-Sectional Perspective View) (FIG. 13 and FIG. 14)

FIG. 13 is a perspective view of the B-B cross-section, showing an exemplary nozzle cooling device formed by combining a first member and a second member of the present disclosure.

FIG. 14 is an enlarged view (perspective view) showing an exemplary B-B cross-section of cooling channels formed by the flush fitting of a helical groove part and a protrusions part of a first member with the outer peripheral surface of a second member of the present disclosure.

FIGS. 13 and 14 show the condition where the inner circumferential surface of a first member 160 and the outer circumferential surface of a second member 260 fit flush.

These diagrams indicate that a helical groove part 130 and a helical protrusions part (fins) 140 are provided at the inner circumferential surface of a first member, and the helical protrusions part (fins) 140 and the outer circumferential surface of the second member 260 are arranged flush, resulting in the helical groove part 130 may perform as a cooling channel 135.

Here, “helical” means a spiral shape, and “helical cooling channel” means a cooling channel having a spiral shape, in which the number of channels is one or predetermined quantities.

It is also indicated that an introduction zone (or recovery zone) is formed by a broader groove part provided inside the inner circumferential surface of a first member 160 and the outer circumferential surface of a second member 260.

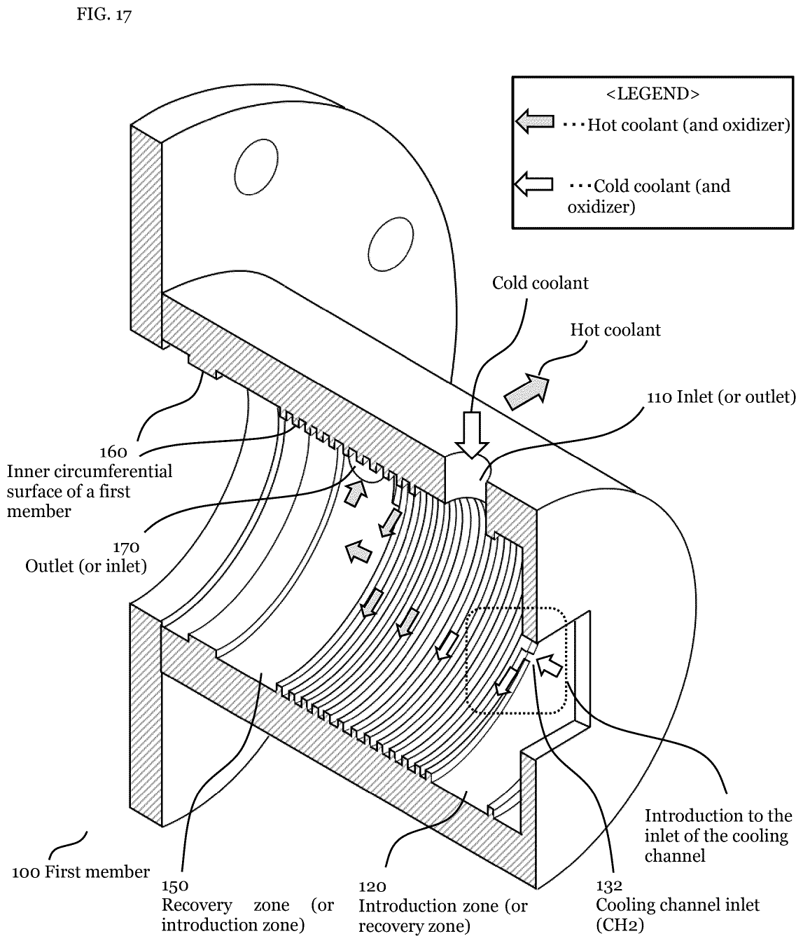

Unlike a helical cooling channel, the introduction zone (or recovery zone) 120 has an annular structure without twisting. The coolant is temporarily stored in this zone and introduced into each cooling channel inlet (See FIG. 17).

A Recovery zone (or introduction zone) 150 works to recover coolant from each cooling channel outlet, and its configuration is the same as that of an introduction zone (or recovery zone) 120.

It is indicated that the coolant supplied via an inlet 110 runs into an introduction zone 120 that is configured with the groove part provided on the inner circumferential surface of the first member 160 and the outer circumferential surface of the second member.

After running into the introduction zone 120, the coolant is passed into each cooling channel via the cooling channel inlet (CH1) 131, (CH2) 132, and so on (Not shown in FIG. 13; See FIGS. 6 and 7).

After passing through the coolant channels, the coolant is heated while cooling the nozzle part and then passed to outlet 170 via a recovery zone 150, which has the same configuration as an introduction zone 120.

As shown in FIG. 13, an introduction zone 120 and a recovery zone 150 are circularly configured to surround the outer circumferential surface of the second member 260.

The dimensions setting of each part may be free depending on the size and output of rockets. For instance, if the length of a second member (nL) is approximately 60 mm and its diameter is approximately 35 mm, an available setting is that each: a cooling channel depth (chd), a coolant channel width (wch), and a fin width (wf) are approximately 1 mm.

2-5. Inner Configurations when a First Member and a Second Member are Combined (Cross-Section View) (FIG. 15)

FIG. 15 is a cross-section view taken along line B-B, showing an exemplary nozzle cooling device formed by combining a first member and a second member according to the present disclosure.

FIG. 15 shows that the cooling device of the present disclosure secures a predetermined distance from the cooling channel 135 to the nozzle throat part 290 (ds), which is subsequently equal to the distance from the outer surface of a second member to the throat part (D2ds).

In this respect, referring to Patent Literature 1 (See FIG. 1) and Patent Literature 2 (See FIG. 2), their cooling channels are formed to connect closely to each nozzle part along the tapered shape of each nozzle part and significantly differ from the configuration of the present disclosure.

In addition, it is also indicated that the helical cooling channel 135 section has a predetermined effective width (hw) that is shorter than the total length of the second member (NL), wherein the second member is equivalent to a nozzle.

In this respect, referring to Patent Literature 1 (See FIG. 1) and Patent Literature 2 (See FIG. 2), their cooling channels are provided along with the total length of the nozzle part and combustion chamber, which significantly differ from the present disclosure.

In addition, focusing on the positional relationship between the helical cooling channel 135 and the nozzle throat part 290, the diagram indicates the configuration where the helical cooling channel 135 arrangement includes the center of the nozzle throat part.

An advantage of such a configuration is that it intensively cools the nozzle throat part 290 and the surrounding area, which can be at the highest temperature, preventing throat erosion.

Furthermore, using conventional techniques, setting the effective width of a helical cooling channel 135 longer than required causes the coolant running in the channel to be excessively heated. Therefore, there is a specific challenge: a risk that an explosive phenomenon would occur when nitrous oxide is used as a coolant, which destroys the cooling channel or nozzle part.

Accordingly, as a result of focusing on this challenge, in the present disclosure, the effective length of a cooling channel (hw) is limited to a shorter than a nozzle total length (nL), for instance, from one-third to one-half of the nozzle total length (nL).

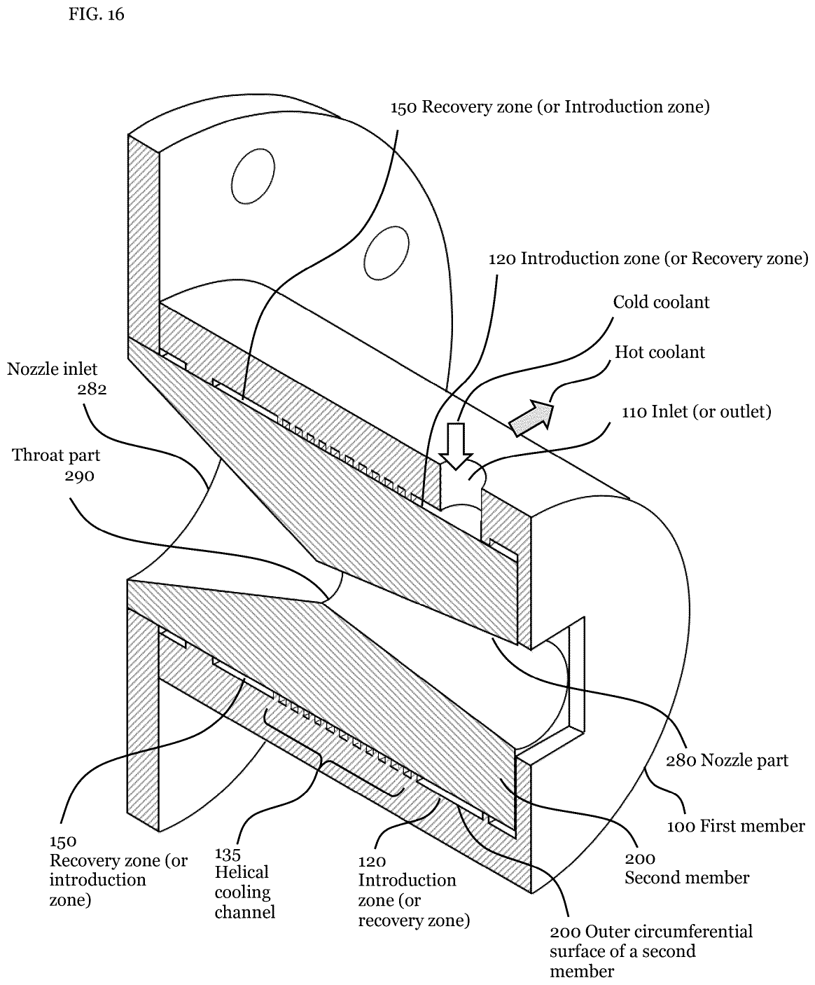

### 2-6. Coolant Flow in a Cooling Device of the Present Disclosure (FIG. 16)

FIG. 16 is a diagram that represents an overview of coolant flow using FIG. 13, which shows an exemplary nozzle cooling device formed by combining a first member and a second member of the present disclosure.

It represents a condition where a cold coolant is provided into the inlet 110 (thick white open arrow) and exhaust from outlet 170 (not shown) as a hot coolant heated by absorbing the nozzle's heat while performing its cooling ability.

2-7. Coolant Flow in a Cooling Device of the Present Disclosure (Schematic Diagram with a Transparency Second Member) (FIG. 17)

Due to the existence of a second member, it is difficult to see coolant flow inside a cooling device. Therefore, we will describe the inside coolant flow using FIG. 17, which has a transparent second member.

FIG. 17 is a diagram in which the second member in FIG. 16 is made transparent to visualize the flow of the coolant therein.

FIG. 17 represents the condition where a coolant is supplied from an inlet 100 and introduced into a coolant channel per channel via an introduction zone 120. It shows, specifically, the coolant being introduced into the inlet 132 of the cooling channel 2 (CH2).

The coolant that is introduced into the cooling channels, a thick white open arrow, flows into the cooling channel located at a predetermined distance, ds, from the nozzle part 280 and throat part 290 provided inside the second member (See FIG. 15). That is why the coolant is not excessively heated, which is a noteworthy point.

In addition, due to a heat exchange using the second member configured with a material having a predetermined thermal conductivity, sufficiently cooling the nozzle part 280 and the throat part 290 and suppressing the erosion of the throat part.

The coolant heated by the heat of the nozzle part (thick gray arrow) is discharged from each outlet of the cooling channels, recovered via a recovery zone 150, and then exhausted outside of the cooling device via outlet 170.

Considering the case without an introduction zone 120, which indicates that each channel has a coolant inlet for a cooling channel, and multiple inlets are provided, it would be difficult to introduce coolant evenly.

Accordingly, providing an introduction zone 120 allows coolant to be introduced evenly into each channel inlet (CH1, CH2, and so on).

A recovery zone 150 also has the same situation regarding solving the issue of recovering a hot coolant from a cooling channel per channel, so its description is omitted.

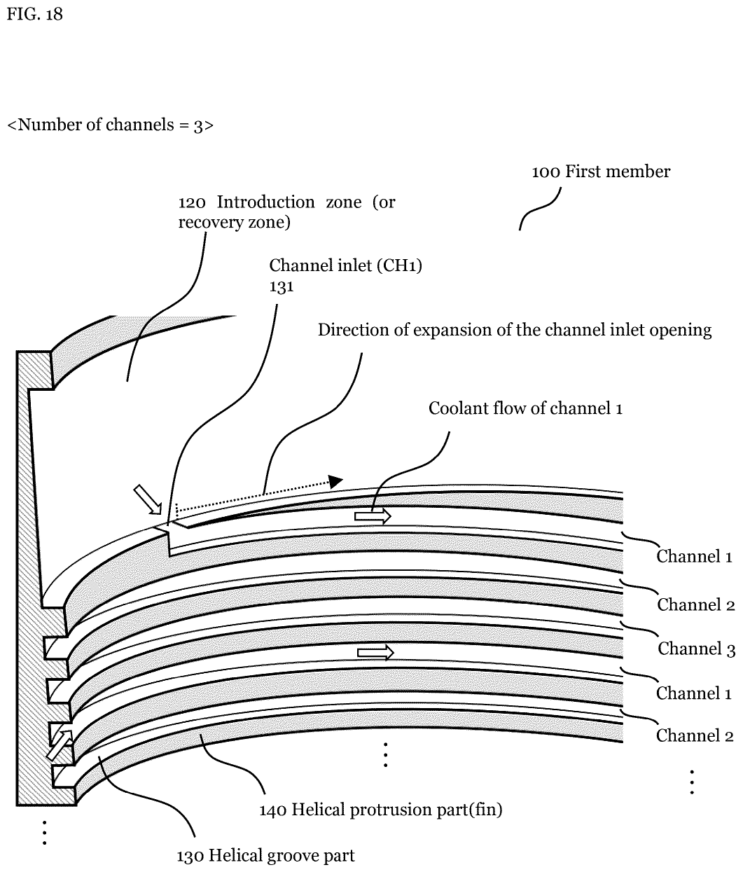

### 2-8. Enlarged View of a Helical Structure (3 CH Case) (FIG. 18)

FIG. 18 is an enlarged view of the “introduction part of a cooling channel inlet” (dotted line portion) in FIG. 17, showing a helical cooling channel configured with a helical groove part and a protrusion part.

It also shows an exemplary coolant flow in each cooling channel when the number of cooling channels n is three.

FIG. 18 shows the condition where a coolant is introduced from the channel inlet of cooling channel 1 (CH 1).

Upon the number of channels n=3, the helical cooling channels are arranged in the order of channel 1, channel 2, and channel 3.

The thick white open arrows indicate such conditions, showing that the coolant flows through only the helical cooling channels of channel 1, which are arranged in every third channel 1.

In addition, in this diagram, the entrance width of a cooling channel inlet (CH1) is almost the same as a cooling channel width (wch) (See FIG. 14), but this is not limited to this.

For instance, if the number of channels is smaller, there is a longer distance between channels. Therefore, it would be possible to enhance the entrance width of a channel inlet toward the direction of expansion of the channel inlet opening (dotted arrow) in FIG. 18 to some extent and secure a larger entrance width.

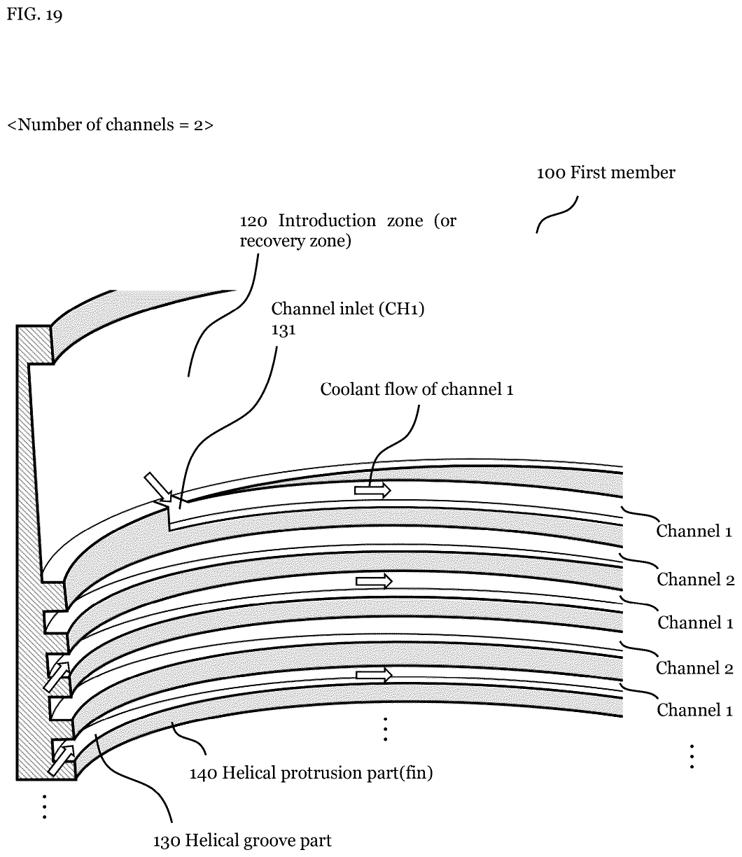

### 2-9. Enlarged View of Helical Structure (2 CH Case) (FIG. 19)

FIG. 19 is an enlarged view of the “introduction part of a cooling channel inlet” (dotted line portion) in FIG. 17, showing helical cooling channels configured with a helical groove part and a protrusion part. It also shows an exemplary coolant flow in each cooling channel when the number of cooling channels n is two.

The difference between FIG. 19 and FIG. 18 is that the number n of cooling channels is 3 or 2.

Upon the channel number n=2, the helical cooling channels are arranged in the order of channel 1 and channel 2 from the top.

The thick white open arrows represent such condition and show that the coolant flows through only the helical cooling channels of channel 1, which are arranged in every second channel.

Having described the cases with the number of channels n=2 or 3 above, it is the same case the number of channels is four or more.

### 2-10. Schematic Difference of Configurations Related to the Number of Channels of Helical Cooling Channels (FIG. 20)

FIG. 20 is a diagram showing an example of differences in the configuration of cooling channels due to differences in the number of cooling channels.

FIG. 20(1) shows that a coolant flows through one cooling channel when the number of channels n=1.

FIG. 20(2) shows that a coolant flows through three cooling channels when the number of channels n=3. It shows the channel arrangement in all three channels and depicts how the arrangement of each channel is shown in two dimensions such that FIG. 18 is configured in three dimensions.

In this case, the inlet of each channel is arranged every 120 degrees.

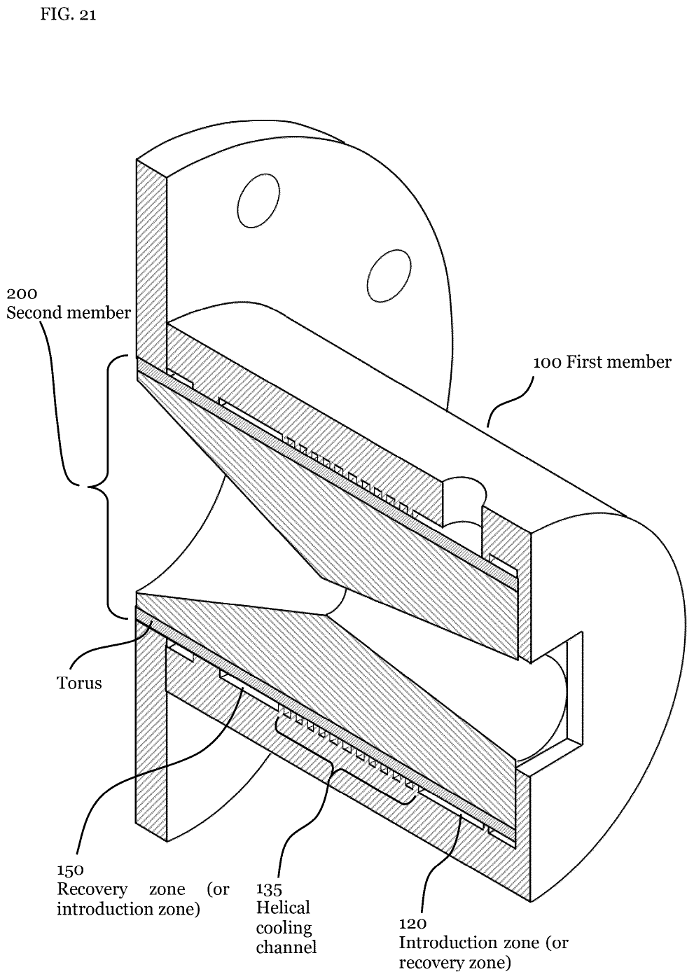

2-11. Cross-Section View Example Having a Second Member with a Two-Piece Structure Upon a First Member and a Second Member are Combined (FIG. 21)

FIG. 21 is a B-B cross-sectional perspective view showing an exemplary cooling device formed by combining a first member and a second member of the present disclosure.

The second member may have an integrated structure including a nozzle part inside, or may have a two-piece structure where the nozzle part is separatable, as shown in FIG. 21.

For instance, an annular member is provided outside the second member to tune the thermal conductivity.

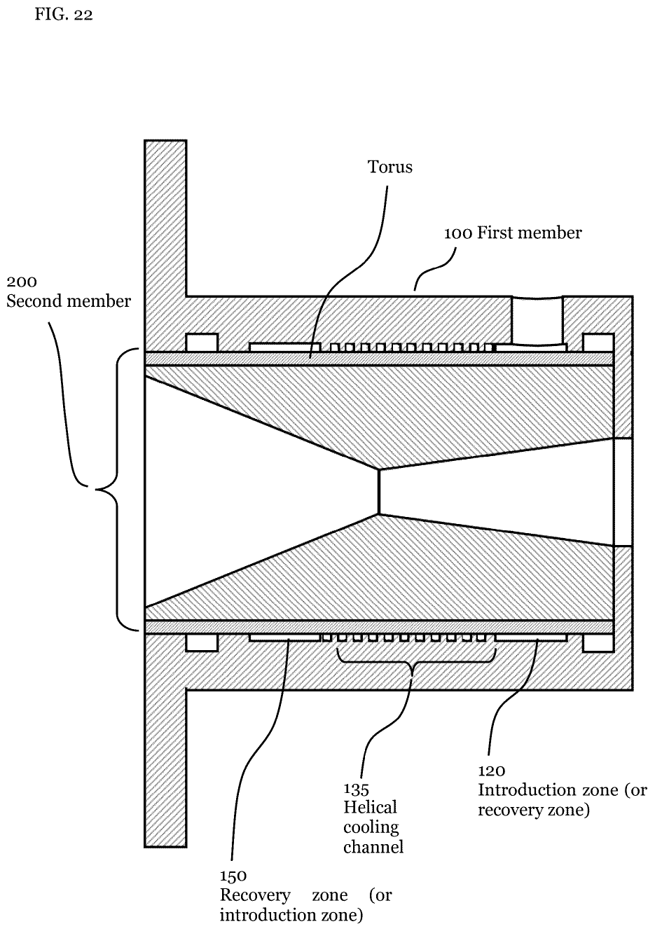

2-12. Cross-Section View Example Having a Second Member with a Two-Piece Structure when a First Member and a Second Member are Combined (FIG. 22)

FIG. 22 is a B-B cross-section view showing an exemplary cooling device formed by combining a first member and a second member of the present disclosure.

### 2-13. Exemplary Configuration of a Second Member Having a Two-Piece Structure

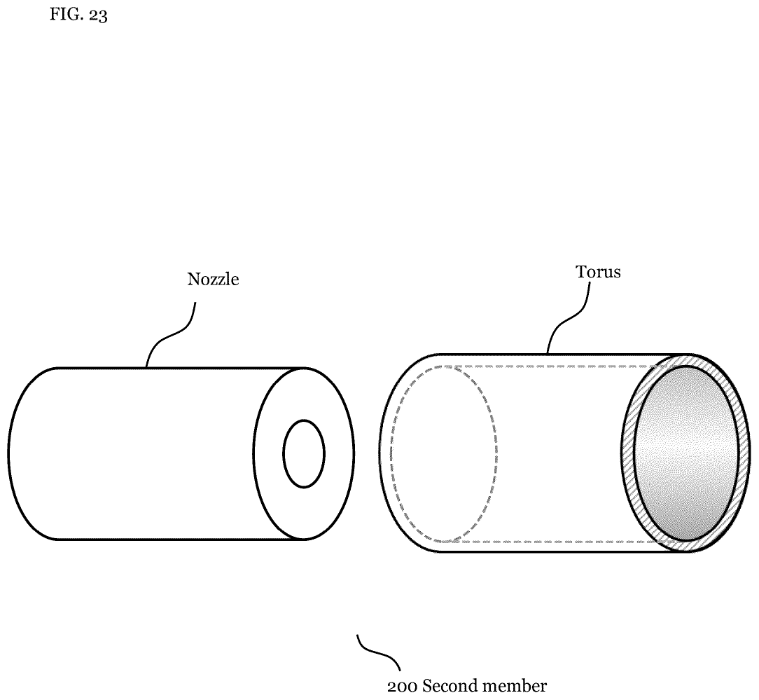

FIG. 23 is a diagram showing an exemplary configuration of a second member of the present disclosure. It shows a modified example in which the second member has a two-piece structure.

FIGS. 21 to 23 show an example where a second member has a two-piece structure respectively. In summary, what is enough inside the first member is a structure with an outer circumferential surface flush with the inner circumferential surface of the first member and a structure equivalent to a nozzle.

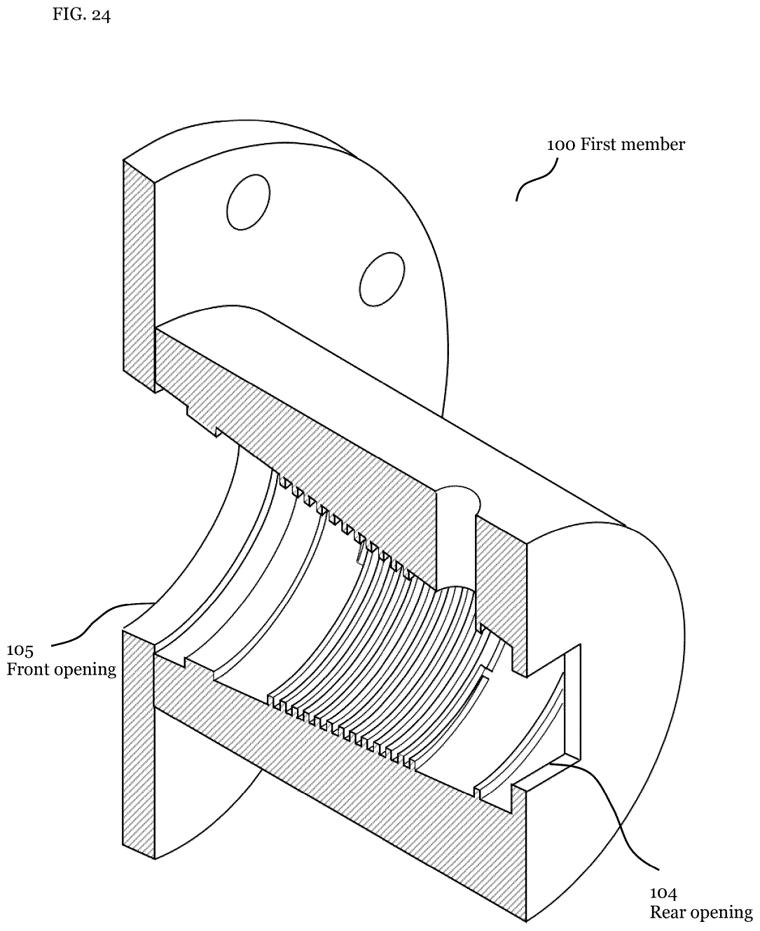

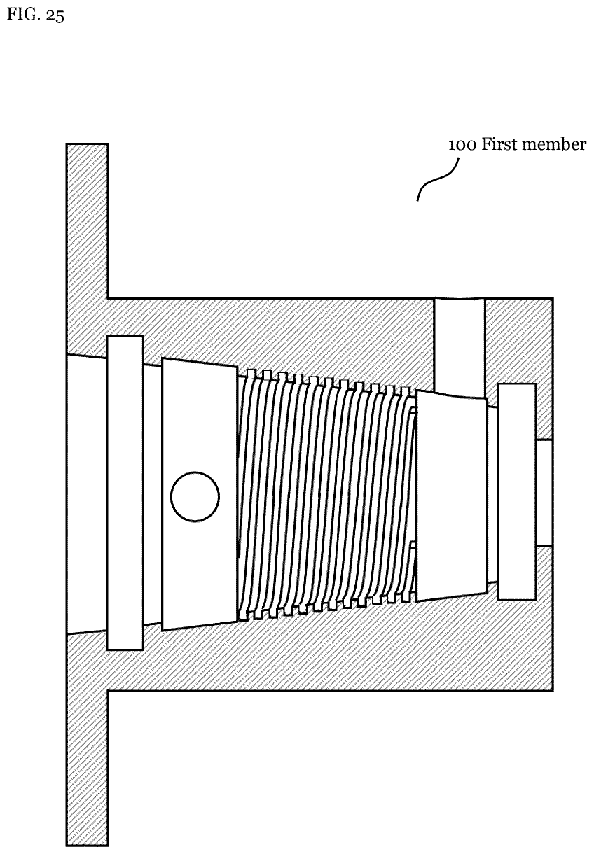

2-14. Exemplary First Member: A Modified One with a Tapered Shape Having a Broader Inlet and Narrower Outlet (FIGS. 24 and 25)

FIGS. 24 and 25 show diagrams showing an exemplary first member of the present disclosure, in which the inner circumferential surface of the first member has a tapered shape that is wide at the inlet and narrows toward the outlet.

FIG. 24 is a B-B cross-sectional perspective view, and FIG. 25 is a B-B cross-section view.

FIGS. 24 and 25 indicate that even with a tapered shape that is wide at the inlet (front opening 105) and narrows toward the outlet, it is possible to make a helical groove and protrusion parts.

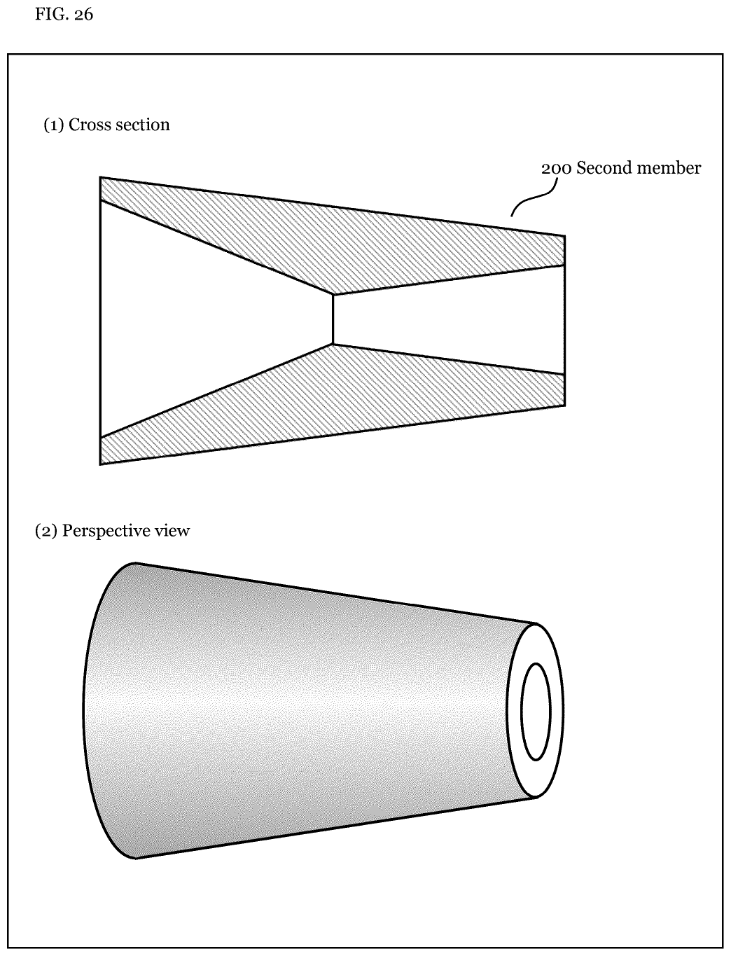

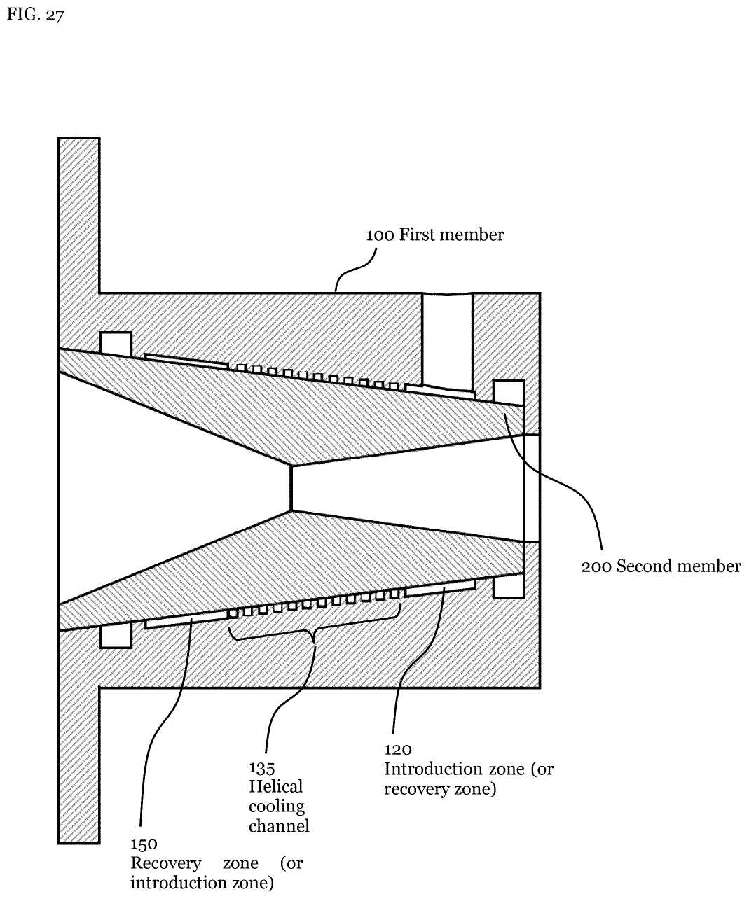

2-15. Exemplary Second Member: A Modified Example with a Tapered Shape Having a Broader Inlet and Narrower Outlet (FIGS. 26 and 27)

FIG. 26 is a diagram showing an example of a first member of the present disclosure: this is a B-B cross-section view of a modified example in which the inner circumferential surface of the second member has a tapered shape that is wide at the inlet and narrows toward the outlet.
(1) is a C-C cross-section view, and (2) is a perspective view.

With respect to a second member to be combined with the first member of FIG. 24 and FIG. 25, the configuration of both members can also be realized due to the tapered shape that is wide at the inlet and narrows toward the outlet.

In this case, when both are combined, the result is like the configuration of FIG. 27.

FIG. 27 is a diagram showing an exemplary cooling device formed by combining the first and second members of the present disclosure.

It is a B-B cross-section view of an exemplary configuration formed by combining a first member and a second member of the present disclosure, in case the first member has an inner circumferential surface of a tapered shape that is wide at the inlet and narrows toward the outlet, and the second member has an outer circumferential surface of a tapered shape that is wide at the inlet and narrows toward the outlet.

FIG. 27 indicates that combining the first and second members forms the helical cooling channel 135 while forming the introduction zone 120 and the recovery zone 150.

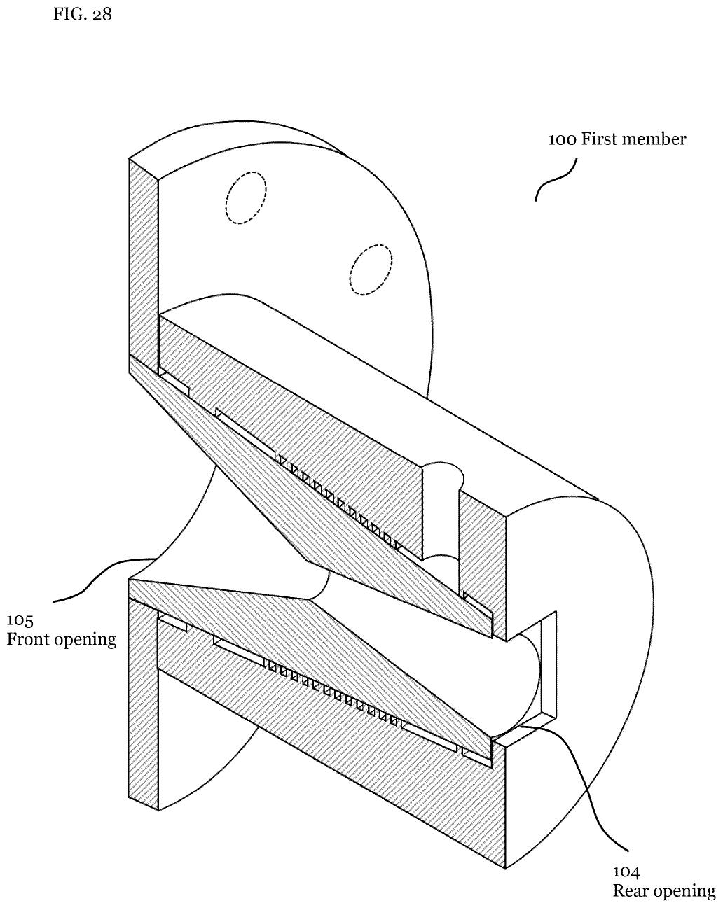

2-16. Modified Example with a Tapered Shape Having a Broader Inlet and Narrower Outlet (FIG. 28 to FIG. 30)

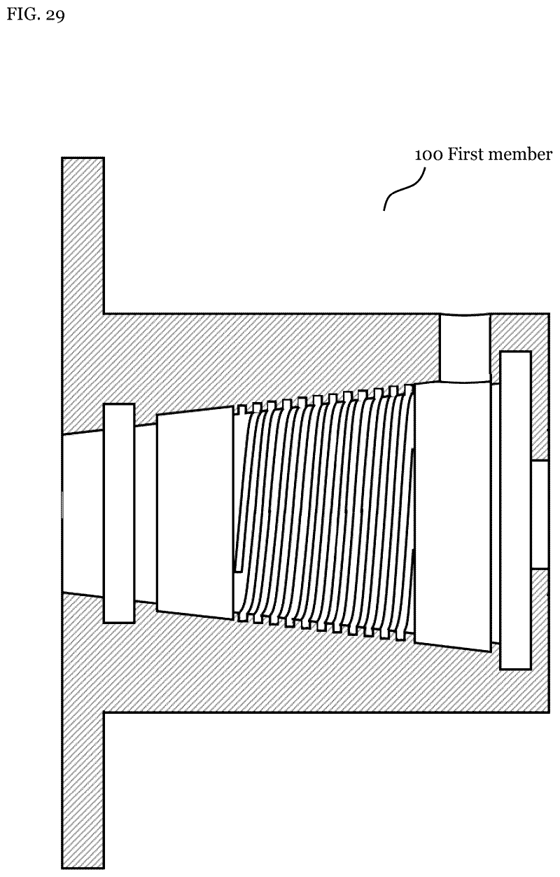

FIGS. 28 and 29 are diagrams showing an example of a first member of the present disclosure. Both are modified examples in which the inner circumferential surface of the first member has a tapered shape that is narrow at the inlet. FIG. 28 is a B-B cross-sectional perspective view, and FIG. 29 is a B-B cross-section view.

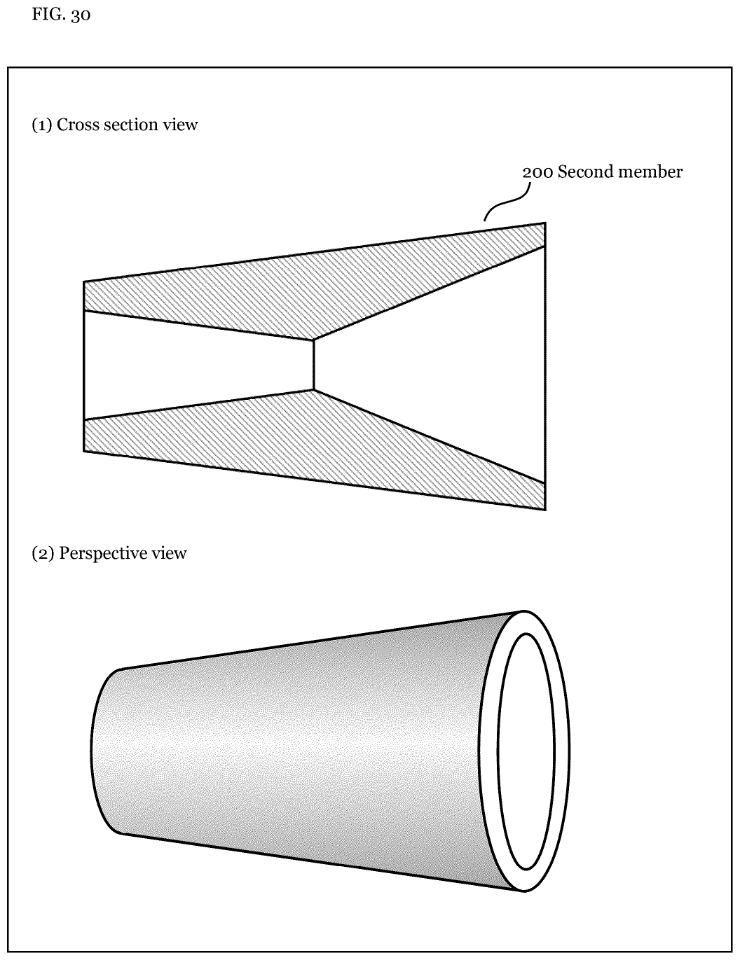

FIG. 30 is a diagram showing an exemplary second member of the present disclosure. It is a modified example in which the outer circumferential surface of the second member has a tapered shape that is narrow at the inlet and changes wider toward the outlet. (1) is a C-C cross-section view, and (2) is a perspective view.

FIG. 28 to FIG. 30 indicate that even with a tapered shape that is wide at the inlet and narrows toward the outlet, an introduction zone 120 and a recovery zone 150 can be formed, as well as a helical cooling channel 135.

### 3. Configuration of a Regenerative Cooling System

Next, we will describe the configuration where a nozzle cooling device of the present disclosure is used for a regenerative cooling system.

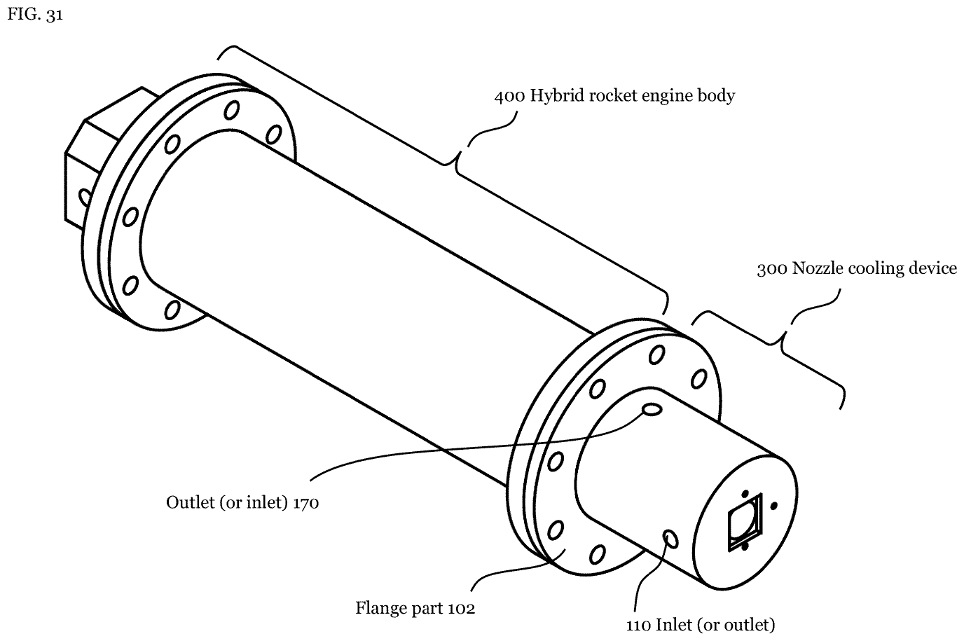

3-1. Exemplary Configuration of a Nozzle Cooling Device of the Present Disclosure Combined with a Hybrid Rocket Engine Body (FIGS. 31 to 33)

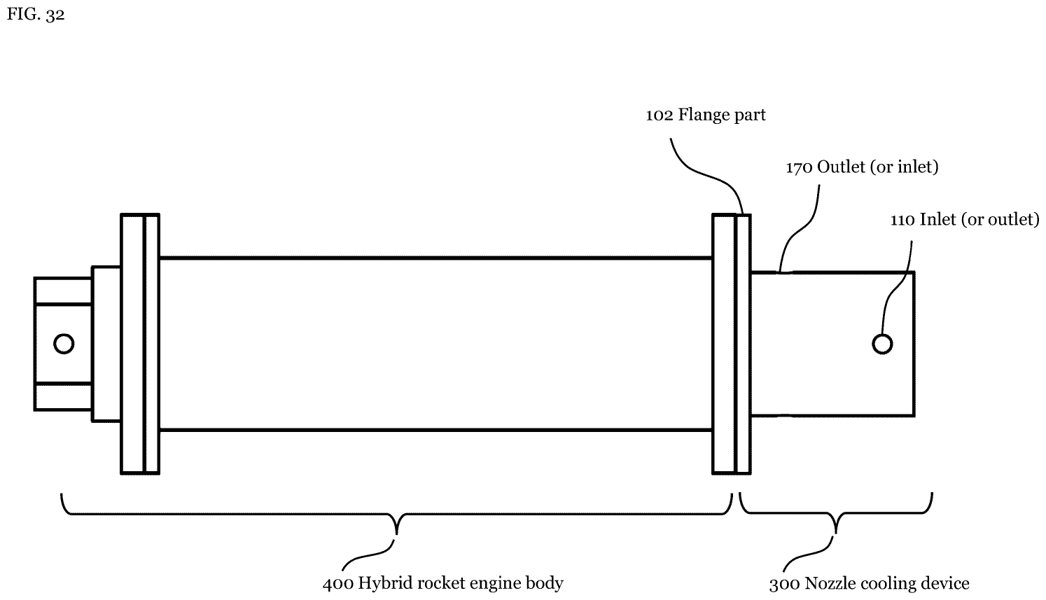

FIGS. 31 and 32 are diagrams showing an exemplary usage of a nozzle cooling device that combines a first member and a second member of the present disclosure. These are perspective and plane views of an exemplary configuration when the cooling device is combined with a hybrid rocket engine body.

FIGS. 31 and 32 indicate that a nozzle cooling device of the present disclosure is connected to a hybrid rocket engine via a flange part 102.

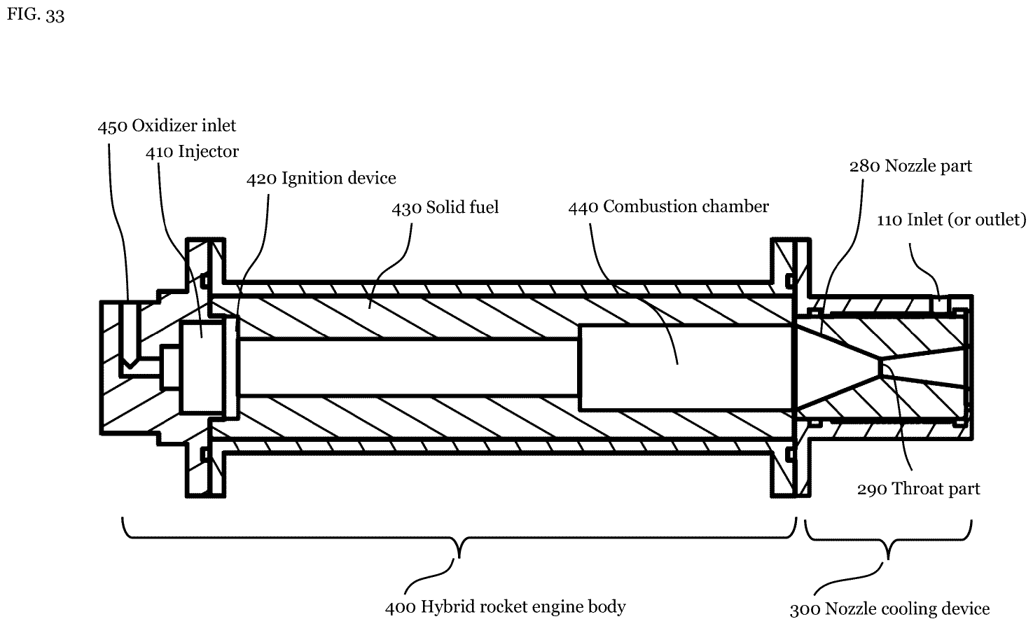

FIG. 33 is a diagram showing an exemplary usage of a nozzle cooling device that combines a first member and a second member of the present disclosure. It is a cross-section view of an exemplary configuration when the cooling device is combined with a hybrid rocket engine body.

A Hybrid rocket engine 400 is configured with an injector 410 that injects an oxidizer, an ignition device 420 that ignites the oxidizer and fuel, a solid fuel 430, a combustion chamber 440, and an oxidizer inlet 450.

In a combustion chamber 440, the oxidizer reacts with the solid fuel and generates high-temperature combustion gas.

By significantly estricting (flow) at the throat part 290, the narrowest part of nozzle part 280, the inside pressure of the combustion chamber 440 is increased, and combustion is promoted. At the same time, the speed of the combustion gas having run through the throat part 290 is accelerated to supersonic speeds to increase the thrust.

Accordingly, the throat part 290 and its surrounding areas are at risk of being exposed to high-temperature combustion gas and damaged by thermal shock or erosional distortion.

Therefore, it is necessary to suppress the erosion of nozzle part 280, particularly throat part 290, by adopting the nozzle of the cooling device of the present disclosure mentioned above.

On the other hand, in a hybrid rocket engine, its combustion is just maintained by a phenomenon called boundary layer combustion, which occurs in a boundary layer a few millimeters from the surface of the solid fuel. Hence, unlike the combustion of solid and liquid propellants, where tens of micrometers separate flame and fuel, the heat supply to the fuel is not necessarily sufficient.

To improve this situation, it is effective to use nitrous oxide as an oxidizer instead of the relatively safe liquid oxygen or hydrogen peroxide. When thermally decomposed, nitrous oxide produces a mixed gas with a higher oxygen partial pressure than the atmosphere and generates a high amount of heat.

Meanwhile, nitrous oxide can cause a sudden temperature increase and an explosive phenomenon, which could critically damage the cooling channel and nozzle.

There are multiple combined challenges, and solving them would not be easy. Still, the research team behind the present disclosure has worked to solve the challenges using nitrous oxide as well as preventing sudden temperature rise compatibly by adopting the ingenuities listed below.

However, it is not necessary to include all items, and it is sufficient to include at least the first one and one or more of the other items.

### [Ingenuity List]

First, provide a helical cooling channel.

Second, set the distance between a cooling channel and a nozzle part.

Third, tune the effective width of a cooling channel to an appropriate range.

Fourth, provide a helical cooling channel for each channel section.

Fifth, optimize the number of helical cooling channels.

Sixth, adjust the material's thermal conductivity around the nozzle to an appropriate range.

Seventh, optimize the position of an orifice to use nitrous oxide in the cooling channel stably.

Furthermore, adding a description, conventional techniques such as Patent Literature 1 and Patent Literature 2 seem not to recognize at least challenges 2 to 7 above (See FIGS. 1 and 2).

In summary, they could be evaluated as follows: the main objective is to improve cooling ability, and they don't have a viewpoint to achieve both satisfying the requirement to adopt nitrous oxide under the hybrid rocket engine combustion characteristics and preventing the coolant from over-heated with understanding about the risk of adopting nitrous oxide.

We have already described about the first to fourth ingenuities so far. Then, we will mainly describe the fifth to seventh ingenuities below.

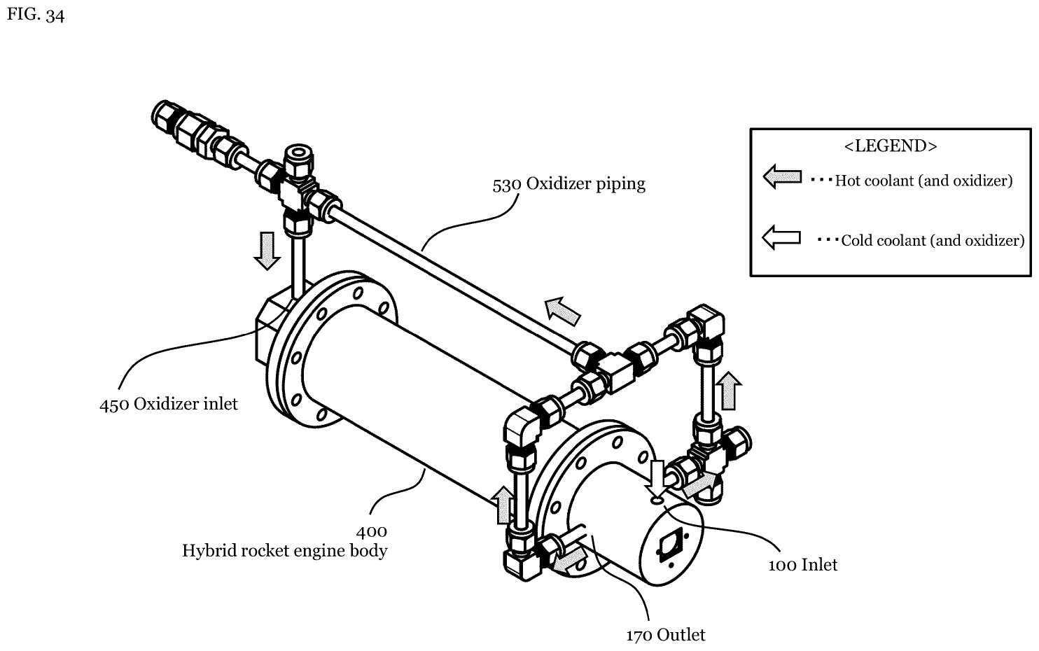

### 3-2. Exemplary Configurations of a Regenerative Cooling System of the Present Disclosure (FIGS. 34 to 36)

FIG. 34 is a diagram showing an exemplary usage of a nozzle cooling device that is formed by combining a first member and a second member of the present disclosure. It is a perspective view of an exemplary regenerative cooling device configuration, including coolant and oxidizer piping, when the cooling device is combined with a hybrid rocket engine body.

In FIG. 34, the piping to inlet 110 is omitted; however, the oxidizer piping 530 connects from outlet 170 to the oxidizer inlet 340 of the hybrid rocket engine 400.

Coolant is supplied into inlet 110. After cooling a nozzle, it is exhausted from outlet 170 and delivered to the oxidizer inlet 450. Finally, it works as an oxidizer to promote the combustion of the rocket engine in space. For this reason, herein, coolant is described as coolant (oxidizer).

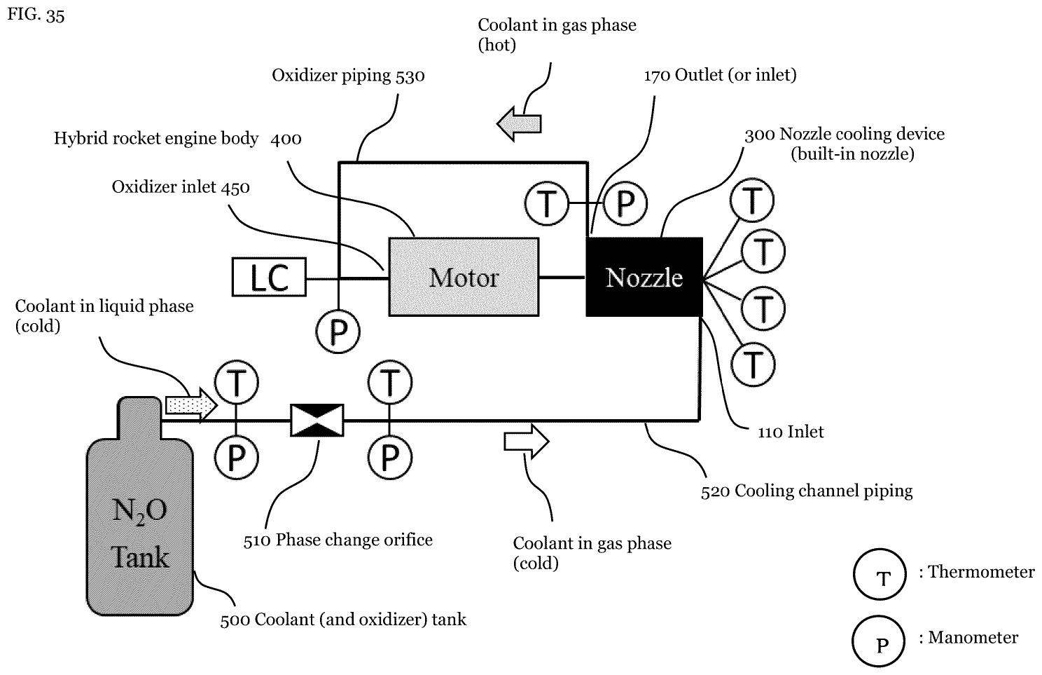

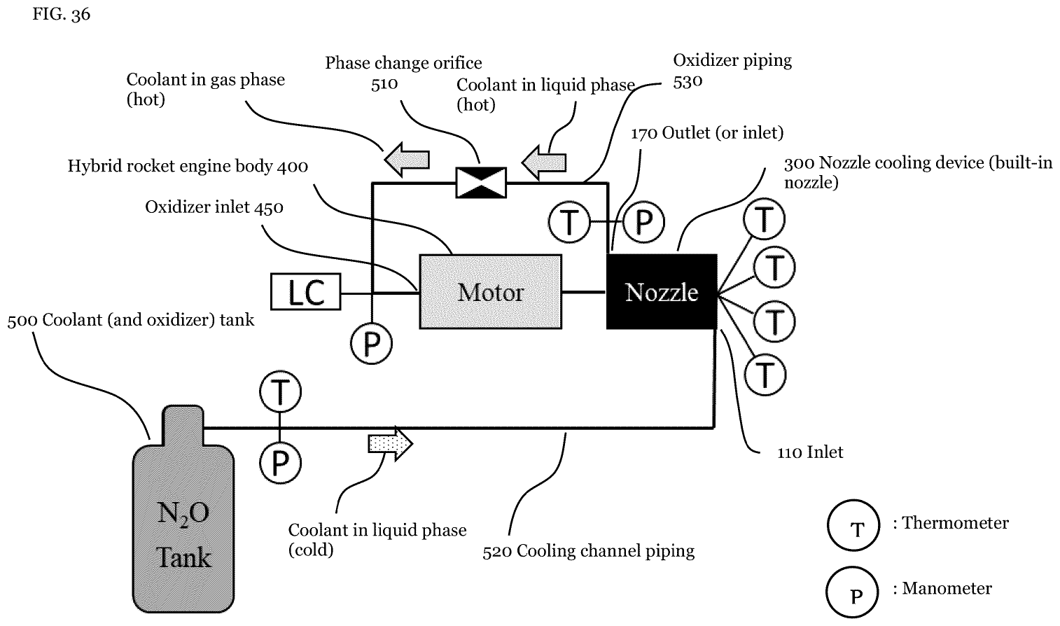

Next, we will describe confrontational examples of a regenerative cooling system of the present disclosure using FIGS. 35 and 36.

FIG. 35 is a diagram showing an exemplary usage in which a nozzle cooling device combines a first member and a second member of the present disclosure. It shows an exemplary regenerative cooling system configuration, including piping for coolant and oxidizer and a phase change orifice arrangement when the cooling device is combined with a hybrid rocket engine body.

In FIG. 35, a thick arrow hatched with tiny dots indicates liquid phase coolant and a thick white open arrow indicates gas phase coolant. In addition, a thick gray arrow indicates heated coolant (gas phase).

FIG. 36 shows a comparison experiment in which the orifice is located differently to use the coolant in the liquid phase for regenerative cooling.

In FIG. 36, a thick arrow hatched with tiny dots indicates a coolant in the liquid phase, and thick gray arrows indicate a hot coolant (in the liquid phase or gas phase).

The symbol “T” represents the position where each temperature sensor is arranged, and the symbol “P” represents the position where each pressure sensor is arranged. Multiple temperature sensors are placed around the nozzle because they are arranged at different distances from the nozzle. The temperature sensors are provided inside a second member, with multiple holes responding to their different distances from the nozzle.

FIG. 35 shows a phase change orifice 510 located between a coolant (and oxidizer) tank 500 and a nozzle cooling device 300.

When running through the phase change orifice 510, the coolant in a liquid phase is vapored and changed into a gas phase. For this reason, in the configuration shown in FIG. 35, the coolant is supplied into the inlet of the nozzle cooling device 300 in a gas phase (aeriform body).

Concerning this point, in FIG. 36, the phase change orifice 510 is located after the nozzle cooling device 300 and just before the hybrid rocket engine 400. This arrangement makes a difference; the coolant provided to the inlet 110 has a liquid phase similar to that inside a tank.

In general, due to the specific heat, coolant would work more effectively in a liquid phase, so it is expected that the configuration of FIG. 36 would have more cooling benefits than that of FIG. 35, in which coolant is provided in the gas phase.

However, the research team of the present disclosure demonstrates that the configuration of FIG. 35 has good cooling performance (the experiment results will be described later), so it is desirable to adopt the configuration of FIG. 35.

The reason the gas phase has better cooling performance is considered: after being supplied to an inlet 110, inside a helical cooling channel 135, due to heat exchange with a nozzle part, the coolant's temperature would increase. In addition, the following characteristics of nitrous oxide would be closely affected.

In other words, nitrous oxide has high vapor pressure (approximately 50 bar), and its vaporization rate increases according to the temperature rise due to a heat exchange. At the same time, the vapor pressure of the vaporized nitrous oxide causes bubbles and a mixture of liquid and bubbles, which is expected to cause a cooling ability drop.

Having said that, the comparison of both only indicates the configuration of FIG. 35 has a higher cooling ability than that of FIG. 36, whichever configuration is expected to be effective enough for the nozzle cooling device.

### 4. Configurations of Helical Cooling Channels and Range of the Number of Channels

### 4-1. Differences in Configurations Related to the Number of Channels

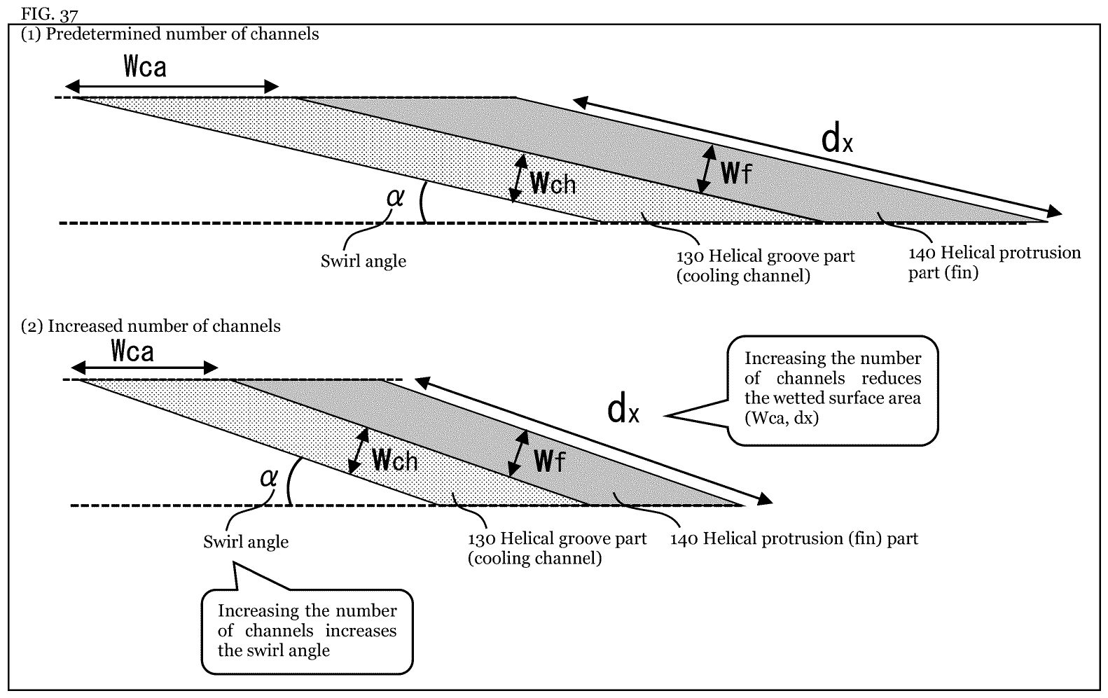

Next, we will describe configurations of helical cooling channels and the number of channels using FIGS. 37 to 40.

FIG. 37 is a diagram showing the difference in the configuration of helical cooling channels depending on the number of channels of the cooling channel, in which (1) shows the case where the number of channels is a predetermined number, and (2) shows the case where the number of channels is increased compared to (1).

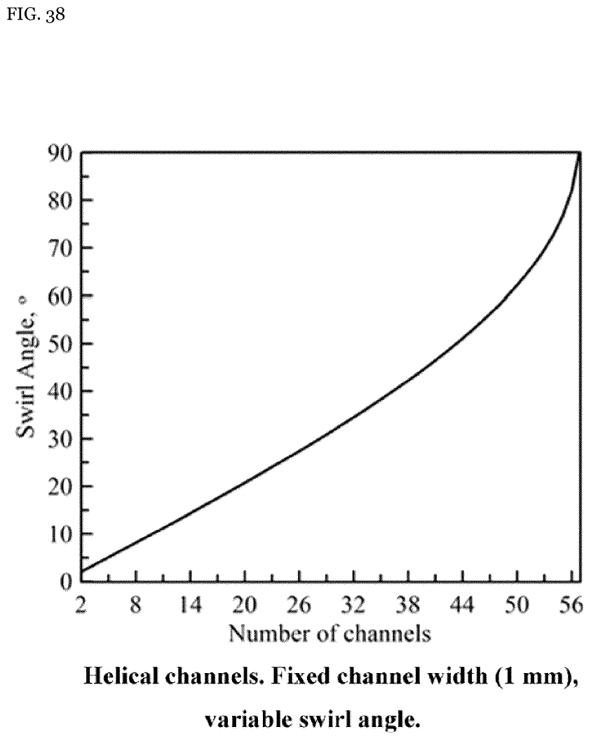

FIG. 38 is a diagram showing the relationship between the number of channels n and a variable swirl angle α in the case of helical cooling channels.

As shown in FIG. 37, in the case of helical cooling channels, even if the number of channels n increases, the flow channel cross-sectional area (proportional to the channel width Wch) does not change. However, as the number of channels n increases, the wet surface (Wca, dx) decreases, and the swirl angle α increases.

FIG. 38 shows the relationship between the number of channels n and a swirl angle α.

FIG. 38 indicates a case where the total nozzle length is 60 mm, and the channel width is 1 mm. When the number of channels is 60 CH, the swirl angle α is 90 degrees, and the cooling channels become the same structure as axial straight channels.

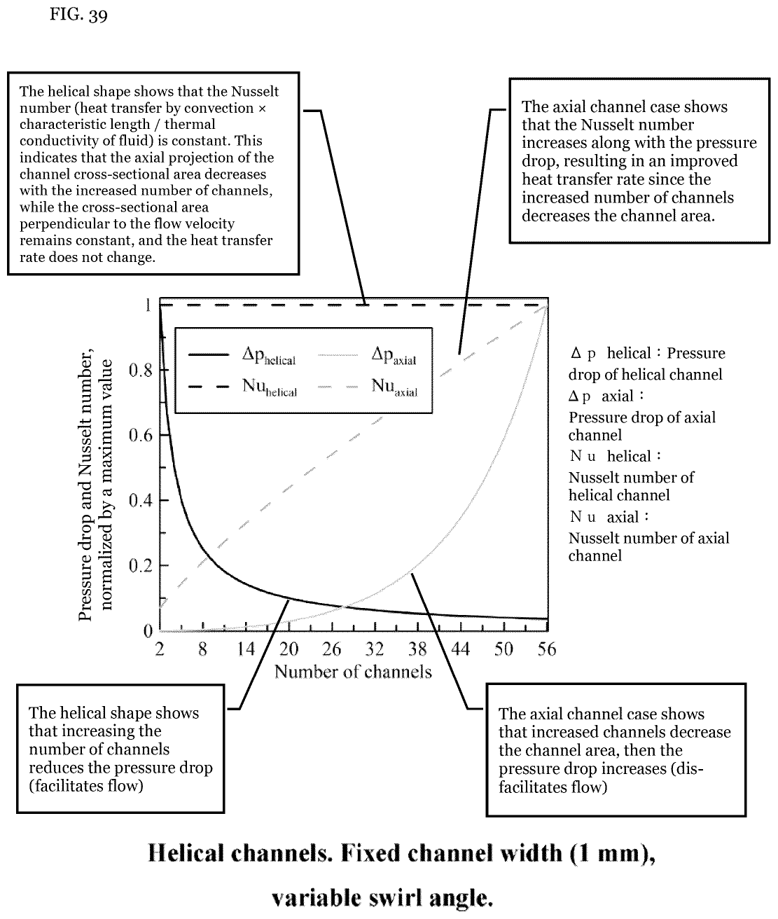

FIG. 39 is a diagram showing the difference between the helical cooling channel case and the axial cooling channel case, particularly the change trends of pressure drop (Δp) and the Nusselt number (Nu).

FIG. 39 indicates, as explained in the speech bubbles in the figure, that in the case of helical cooling channels, the Nusselt number (heat transfer of convection x the representative length/heat transfer of convection fluid) is steady, therefore even if the number of channels increases, only the axial projection of the channel cross-sectional area is reduced. In contrast, the cross-sectional area perpendicular to the flow velocity remains steady, and the heat transfer rate doesn't change.

In addition, in the case of helical cooling channels, this diagram indicates that if the number of channels increases, the pressure drop decreases (easy to flow).

Therefore, FIGS. 37 to 39 indicate that in the case of helical cooling channels, even if the number of channels increases, the heat transfer rate doesn't change. In contrast, even though the pressure drop decreases, the wet surface (Wca, dx) decreases, and the cooling effectiveness decreases. Hence, a small channel number, such as 2 to 8 CH, would be preferable (See the experiment results below).

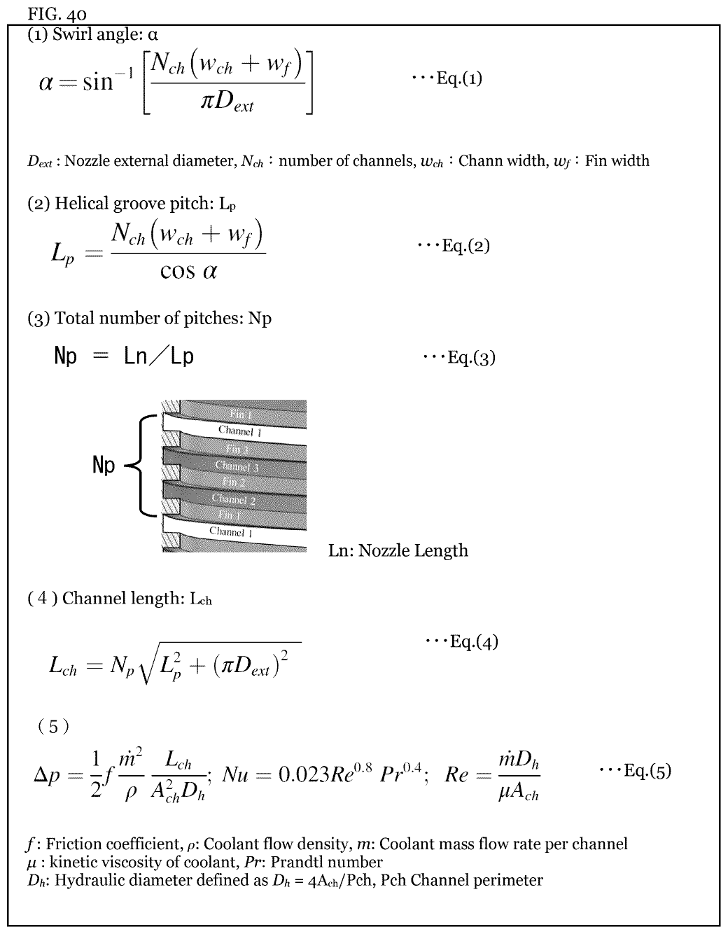

FIG. 40 shows calculation formulas for the configuration of helical cooling channels.

Equation (1) shows the calculation formula for the swirl angle α, and corresponds to the graph in FIG. 38.

For instance, when the number of channels n=3, the swirl angle α can be calculated to be approximately 3 degrees.

Equation (2) shows the calculation formula for the pitch (Lp) of the helical grooves.

Equation (3) shows the calculation formula for the total number of pitches (Np).

Equation (4) shows the calculation formula for the channel length (Lch). By substituting equations (2) and (3), when the nozzle length (Ln) is 60 mm, the channel length (Lch) of the helical cooling channel is calculated to be approximately 1 m.

From this, it can be seen that the helical cooling channel's channel length (length of the flow path) is approximately 17 times the length of the axial flow path.

Furthermore, as a calculation formula for evaluating the effect of the number of channels n on the abilities of a cooling system, equation (5) relates to the pressure drop Δp of the turbulent flow through a pipe (definition of the Darcy-Weisbach friction coefficient) and the convective heat transfer coefficient (Dittas-Boelter equation), and corresponds to the graph in FIG. 39.

### 4-2. Differences in Nozzle Temperatures, Fluid Heat Transfer Coefficient, and Pressure Drop Depending on the Number of Channels

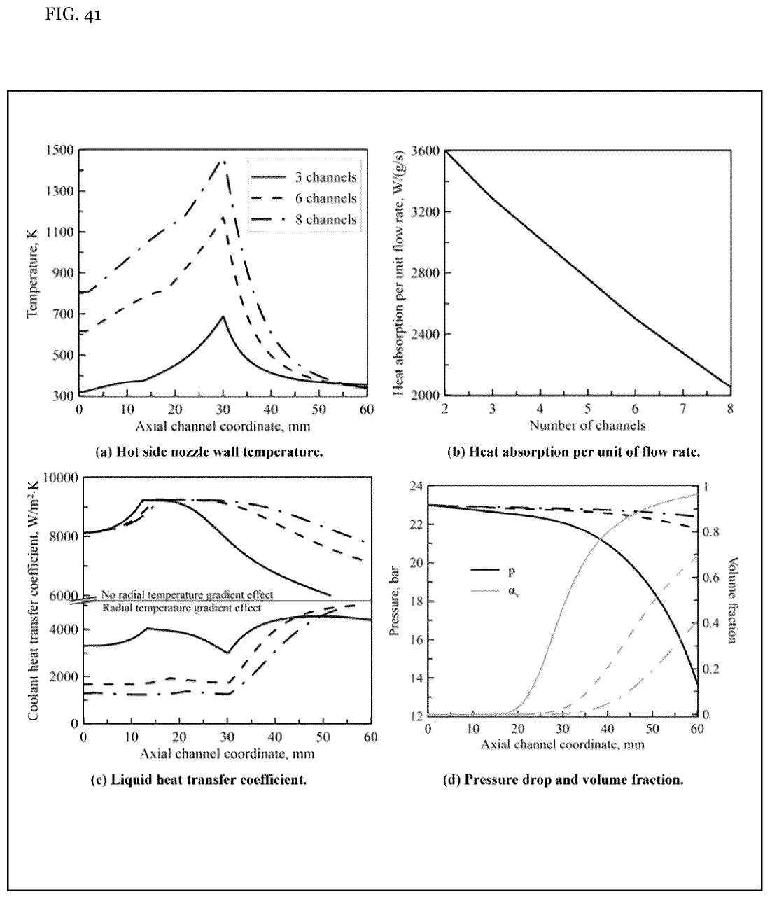

Next, using FIG. 41, we will describe the differences in nozzle temperatures, liquid heat transfer coefficient, and pressure drop when the number of channels n is changed.

FIG. 41 indicates (a) Nozzle temperature, (b) Heat absorption per unit flow rate, (c) fluid heat transfer coefficient (coolant's heat transfer coefficient), and (d) Pressure drop and gas volume fraction, which, depending on the number of channels when the coolant pressure is 23 bar and coolant temperature is 119 K (approximately −154° C.) in inlet 100.

From now on, using FIG. 41, we will discuss the three cases where the number of channels n is 3, 6, or 8.

FIG. 41(a) shows the nozzle temperatures of each channel corresponding to a position in the nozzle length of 60 mm.

FIG. 41(a) indicates that the cooling ability was highest when the number of channels n=3. Even if the number of channels n=8, the highest temperature was 1400 K (approximately 1127° C.), slightly lower than the critical temperature of nozzle erosion. Thus, it would be possible to secure a stable cooling ability.

While it doesn't show the data with the number of channels n=2, its cooling ability could be regarded as the same as that with the number of channels n=3. Therefore, by the research team of the present disclosure's decision, it is practical when the number of channels is n=2 to 8.

The remaining challenge related to pressure drop is finding the practical range without using pressure pumps upon used as an oxidizer for hybrid rocket engines.

With respect to this point, as shown above in FIGS. 37 to 39, FIG. 41(a) indicates that in the case of helical cooling channels, even if the number of channels increased, the heat transfer rate didn't change. In contrast, even though the pressure drop decreased, the wet surface (Wca, dx) decreased, and the cooling effectiveness decreased. Hence, a small channel number, such as 2 to 8 CH, would be preferable.

FIG. 41(b) indicates, as evidence, that there was a trend for the amount of heat absorption per unit flow rate to decrease, which corresponded to the relationship upon the number of channels increased, the wet surface (Wca, dx) decreased.

FIG. 41(c) shows the changing trend of the liquid heat transfer coefficient (when the number of channels n=3, 6, or 8), which corresponds to a position in the nozzle length of 60 mm.

FIG. 41(d) shows the changing trend of the pressure drop and gas volume fraction (when the number of channels n=3, 6, or 8), corresponding to a position in the nozzle axial direction length of 60 mm.

The results with respect to the changing trend of the pressure are the same as the assumptions: in the 3 CH case, it significantly decreased, and in the 6 and 8 cases, it didn't decrease so much. It shows, specifically, that the pressure drop was 13.5 bar (3 CH), 1.0 bar (6 CH), and 0.5 bar (8 CH). Therefore, it indicates that the pressure drop decreased as the number of channels n increased.

In addition, with respect to gas volume fractions, it gradually decreased from 0.96 (3 CH) to 0.70 (6 CH) and 0.4 (8 CH).

As discussed above, increasing the number of channels in a cooling system improves the pressure drop; however, the cooling ability gradually decreases, and the possibility of nozzle erosion increases.

Therefore, it might be practical to use when the number of channels is from one to a dozen. However, two to eight channels would be preferable.

In this case, the swirl angle α ranges from approximately 2 to 10 degrees (See FIG. 38).

### 5. Thermal Conductivities of the Members in the Nozzle Configuration

If a nozzle part 280 is arranged inside a second member, depending on the material of the second member, its cooling ability changes, and the ability to prevent erosion of the nozzle part 280 changes.

In addition, if a nozzle part is arranged inside a second member, depending on the material of the second member, coolant is excessively heated by the heat exchange with the nozzle part 280 (particularly throat part 290), which changes the ability to suppress explosive phenomenon occasions.

Graphite is selected as the material of a second member for a nozzle cooling device of the present disclosure.

Graphite is produced by a high-temperature heat treatment process called graphitization and is a mass of regularly arranged carbon.

Graphite is organized by intermolecular bonds in the Z-axial direction. Therefore, it has a lower thermal conductivity in the Z-axil than in the X or Y-axil directions. It is an anisotropic material with different natures depending on the directions.

Accordingly, although graphite's thermal conductivity alone is generally 100 to 250 W/(m·K), it differs due to the lamination condition or thickness.

Isotropic graphite, which is formed by applying equal pressure from all directions, has also been used in practice. Then, depending on its manufacturing method or thickness, the thermal conductivity can be controlled.

In the present disclosure, isotropic graphite is used, and the experiments were conducted under the condition that the thermal conductivity between a throat part and cooling channels ranges from approximately 20 to 130 W/(m·K).

Regarding this condition, isotropic graphite has the benefit of tuning the cooling ability to prevent the coolant in the cooling channels from being excessively heated. This differs from the case of copper, whose thermal conductivity is as high as approximately 370 W (m·K), or inconel alloy, whose thermal conductivity is as low as approximately 10 W (m. K).

Graphite's heat resistance as a single material is said to be −200° C. to 450° C. in air and 3000° C. in a non-oxidizing atmosphere.

The temperature of the rocket engine's combustion gas can be as high as 2500° C. or more. However, graphite resists sudden heat changes and becomes harder in high-temperature circumstances. Therefore, it is preferable to rocket engine nozzles.

### 6. Coolant and Oxidizer

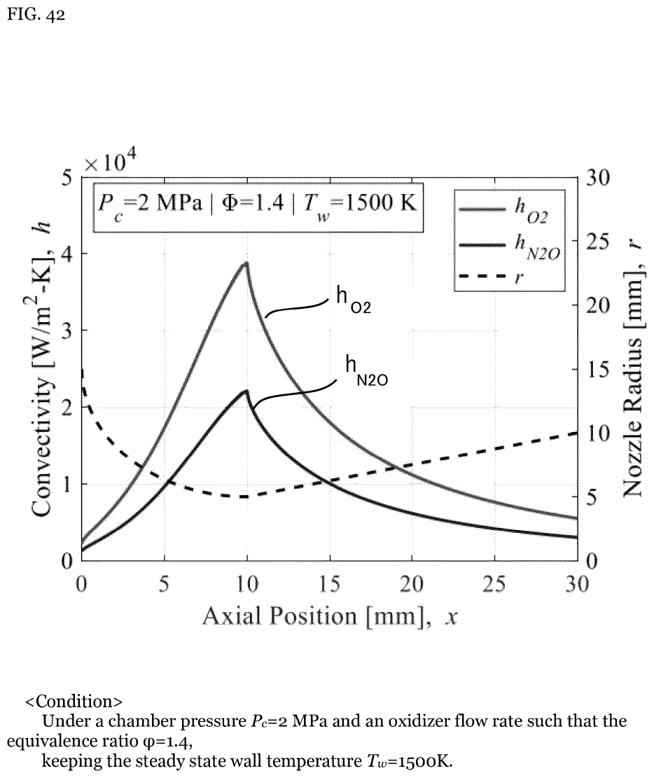

FIG. 42 shows convection heat transfer coefficient profiles calculated using the correlation of Bartz's formula, in which the diameter of the nozzle throat area (nsd) was 10 mm, the diameter of the outlet (nod) was 20 mm, and the nozzle skirt was attached (corresponds to throat part) at the position of r (dashed line).

FIG. 42 indicates that the heat input amount when using liquid oxygen (hO2) was higher than that of using nitrous oxide as an oxidizer (hN2O).

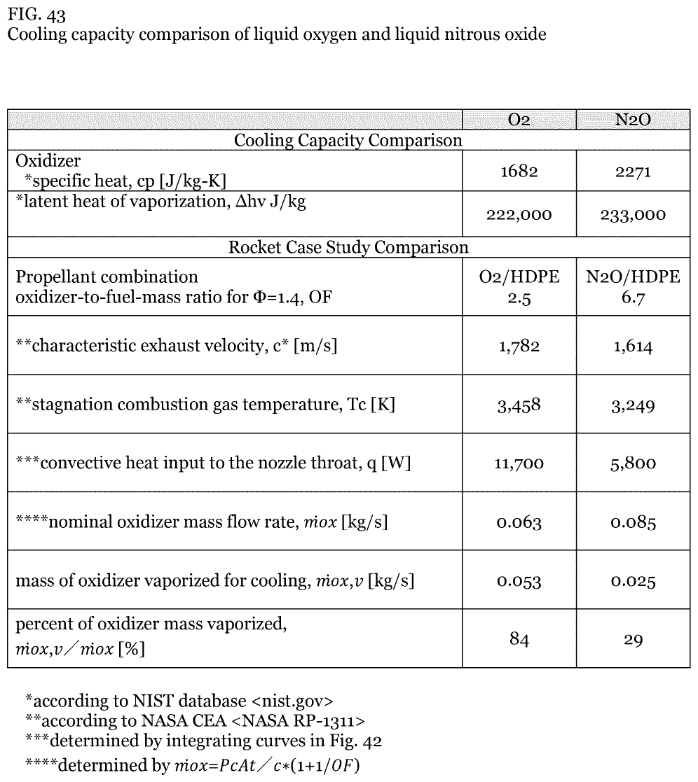

FIG. 43 is a diagram comparing the characteristics of liquid oxygen and liquid nitrous oxide.

It summarizes, in particular, major calculation results, which are used to decide whether it is possible to keep the steady wall temperature Tw=1500 K under the oxidizer flow rate conditions: chamber pressure Pc=2 Mpa and equivalent ratio ø=1.4.

Referring to FIG. 43, it is remarkable that nitrous oxide has higher specific heat and latent heat of vaporization, leading to its high cooling ability.

Combined with the decrease in the heat input to a throat part, the cooling ability of an N2O/HDPE hybrid rocket would be higher than that of an O2/HDPE hybrid rocket.

In addition, from the viewpoint of mass, for the sake of regenerative cooling, twice the amount of oxidizer is required to be vaporized for an O2/HDPE hybrid rocket than that of a N2O/HDPE hybrid rocket. This amount is also quantified from the viewpoint of the oxidizer flow rate ratio, which is required for vaporization to achieve steady heat transfer in a throat.

In this way, nitrous oxide (N2O) is highly effective as a coolant, even though its critical temperature is 36.5° C., close to room temperature. At the same time, nitrous is at risk of thermal decomposition as temperature rises, which requires careful heating.

### 7. Performance Evaluation of Nozzle Cooling Devices and the Regenerative Cooling Systems of the Present Disclosure

Next, we will describe the performance evaluations (effects) of the present disclosure's nozzle cooling devices and regenerative cooling systems.

Nozzles made from isotropic graphite were used in the experiments.

These nozzles had three holes to insert sheath-type thermocouple leads, and the nozzle temperatures were measured at positions 3, 5, 8.5, and 12 mm from the inner surface of the throat.

The nozzle's total length was 60 mm, and the throat was configured as located in the middle. The diameters of the converging inlet, throat, and outlet parts are 30 mm, 6 mm, and 14 mm, respectively (see FIGS. 8 to 10).

The helical grooves and protrusion part were 1 mm wide and 1 mm high, and the number of channels n is 3 (see FIGS. 3 to 7 and 13 to 19).

Helical groove part 130 may be manufactured by 3D printing.

Coolant flows in the reverse direction of the exhaust gas in the nozzle. The hot coolant was injected, via oxidizer piping 530, into the oxidizer inlet 450 and then into the main chamber of the hybrid rocket engine body 400 (See FIG. 34).

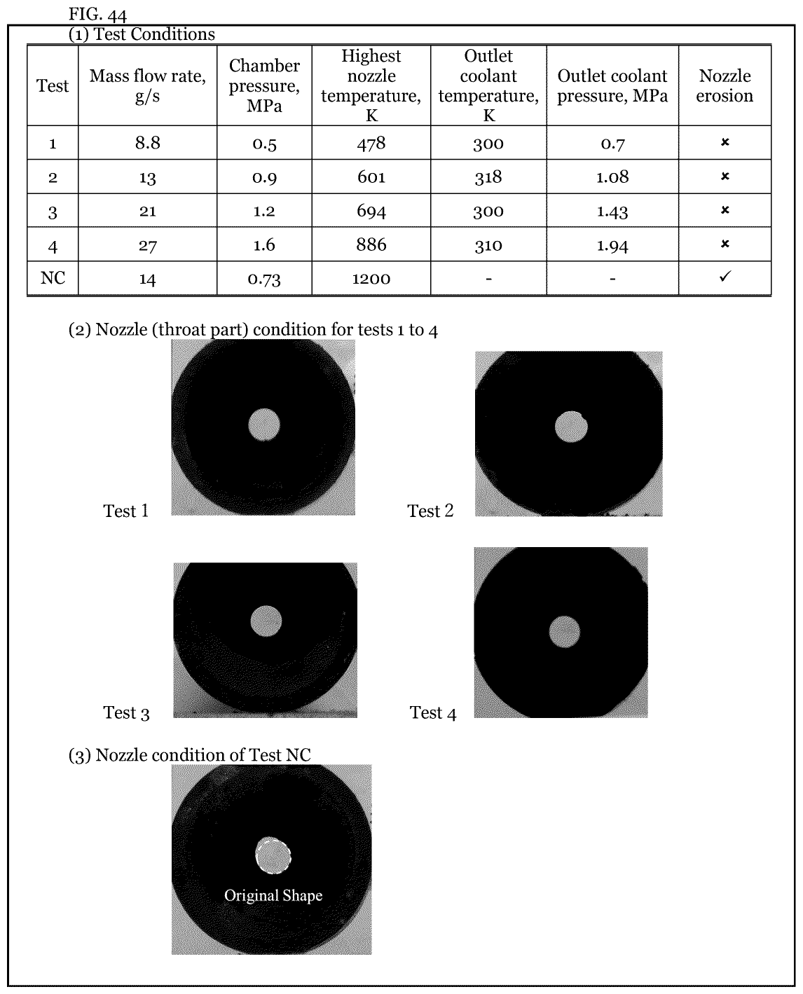

FIG. 44(1) is an experimental condition table.

It shows the conditions under which the coolant (and oxidant) mass flow rates are 8.8 g/s, 13 g/s, 21 g/s, and 27 g/s, respectively.

For instance, a chamber pressure of 1.6 MPa is obtained with a mass flow rate of 27 g/s. This value is considered high for this thrust scale and can be regarded as the upper limit for this setting.

An additional test, labeled “Test NC (No Cooling),” was also performed without the use of the regenerative cooling system.

As a result of the experiments, no erosion of the nozzle (throat part) was observed in any of the tests (See FIG. 44(2)) with a regenerative cooling system. In contrast, in the test without cooling, erosion of the nozzle (throat part) was observed; a part of the throat with a circular cross-section expanded by about 20% in diameter, deforming into an ellipse and expanding by nearly 10% in the area.

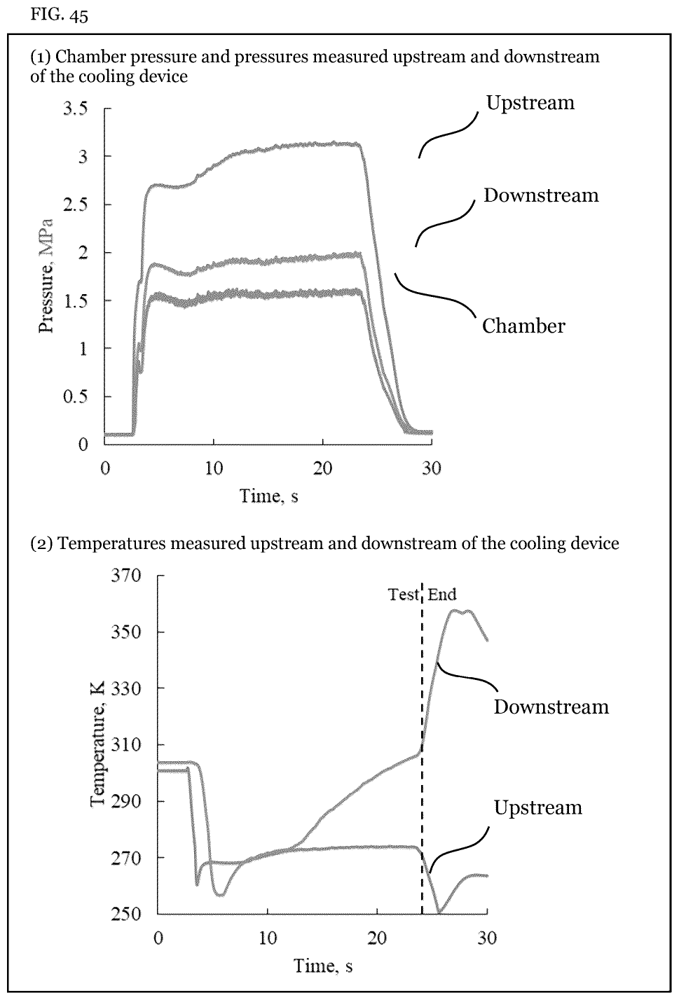

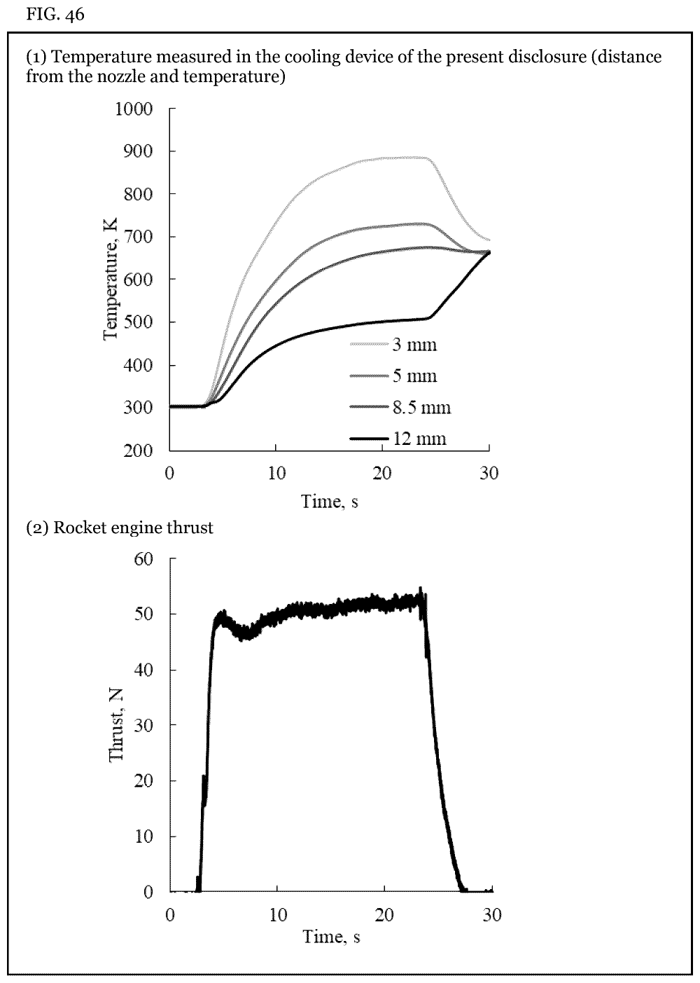

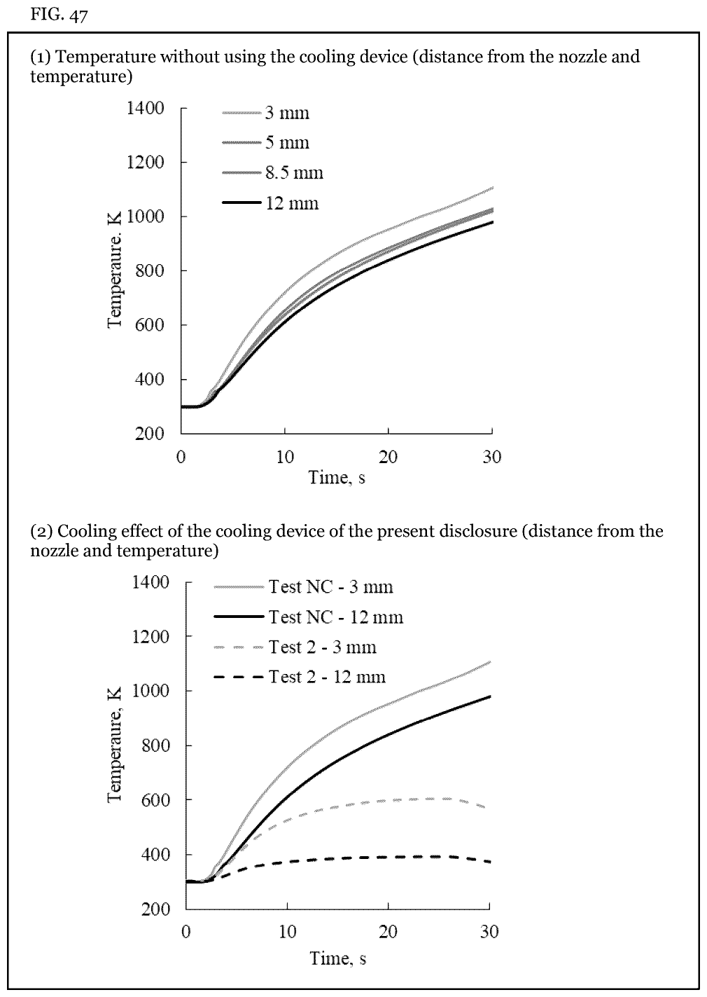

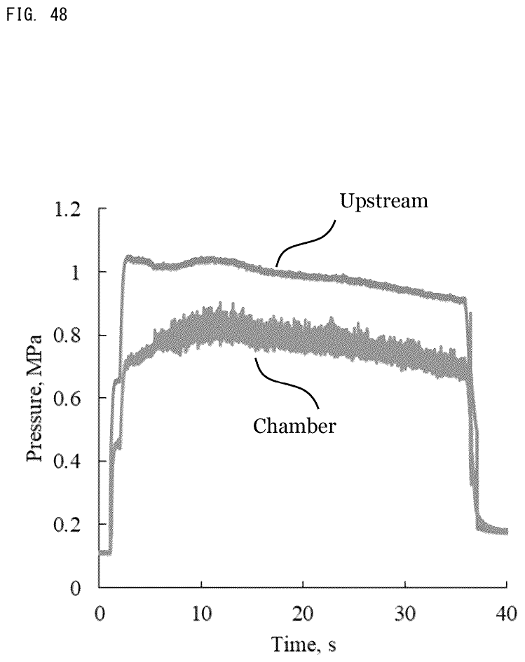

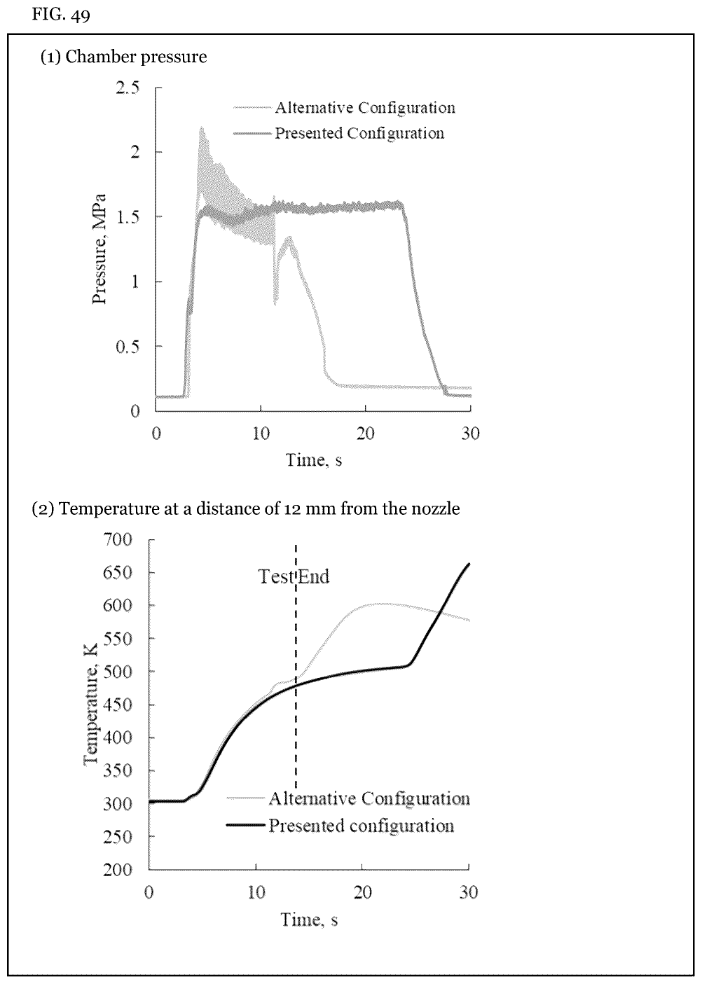

The performance evaluation results in FIGS. 45 and 46 show the Test 4 results with the system configuration shown in FIG. 35, and in FIG. 47, Test NC (without cooling), and Test 2 results. FIG. 48 shows the system configuration of Test NC (without cooling). FIG. 49 shows the test results of the system configuration shown in FIG. 36.

FIG. 45 shows the performance of the cooling device and regenerative cooling system of the present disclosure.

FIG. 45(1) shows the chamber pressure of the coolant tank and the pressures measured upstream and downstream of the regenerative cooling system during the experiments. FIG. 45(2) shows the temperatures measured upstream and downstream of the cooling system.

FIG. 45(1) indicates that the pressure measured along the cooling system and the pressure inside the chamber of the cooling tank was steady during the experiments, and there was no localized decomposition or explosion.

FIG. 45(2) shows the temperatures measured upstream and downstream of the cooling system.

Here, “upstream” of a cooling system is a cooling channel piping 520, “downstream” is the position just after the nozzle of a cooling channel piping 530, and a chamber is the region around the oxidizer inlet 450 of a hybrid rocket engine body 400.

FIG. 45(2) indicates that the temperatures did not reach their steady states at the end of the burn time of approximately 25 seconds. However, the highest temperature reached is around 300 K (approximately 27° C.), which has a considerable margin until the activation temperature of the dissociation reaction, which occurs between 700 and 900 K (approximately 427 and 627° C.).

In addition, in many applications, each injection time is as short as a few seconds to about 10 seconds, so there would be more margin in practical use.

FIG. 46 shows the performance of the cooling device and regenerative cooling system of the present disclosure.

FIG. 46(1) shows the distance from the nozzle and the temperature. FIG. 46(2) shows the rocket engine's thrust during the experiments to check that constant fuel injection is maintained.

FIG. 46(1) shows the temperatures measured inside the nozzle (inside of the second member) located at different distances from the throat part 290. With the implementation of the cooling system, the temperature field inside the nozzle reached a steady state. The innermost thermocouple (closest to the throat part) reached a steady-state temperature of approximately 900 K (approximately 627° C.), and the outermost thermocouple (farthest from the throat part) reached a steady-state temperature of approximately 500 K (approximately 227° C.).

Since erosion of the throat part 290 can be suppressed if the temperature is approximately 1400 K (approximately 1127° C.) or less, the experimental results are considered to fully satisfy the expected performance.

FIG. 46(2) shows the motor thrust (rocket engine output) was steady and continuous at approximately 40 N during the experiments, which indicated that the same levels of combustion continued and that the same flow of coolant (and oxidizer) continued.

Accordingly, the performance shown in the experiments should be expected to demonstrate its capacity even in longer operations.

FIG. 47 is a diagram for exploring the performance of a cooling device and a regenerative cooling system of the present disclosure. FIG. 47(1) shows the temperature (distance from the nozzle and temperature) without a cooling system. FIG. 47(2) shows the cooling effect (distance from the nozzle and temperature) of a cooling system of the present disclosure under the same conditions as FIG. 47(1).

The same conditions mean that the nozzles have the same dimensions as described in paragraph 0130, as well as the same combustion conditions.

FIG. 47(1) indicates that the temperatures continued to rise and did not reach their steady state.

FIG. 47(1) shows that the highest temperature near the throat 290 was approximately 1200 K (approximately 927° C.), and the temperature near the outer metal case of the motor (rocket engine main body) was high at approximately 1000 K (approximately 727° C.).

Therefore, it can be seen that the difference between such high temperatures and the temperature at which erosion of a throat part 290 began was small, and the margin was not enough.

FIG. 47(2) indicates when a cooling system of the present disclosure was used, the temperature was reduced by 800 K (527° C.) compared to when the cooling system was not used.

FIG. 48 is a diagram for exploring the performance of a cooling device and regenerative cooling system of the present disclosure. It shows the pressures recorded downstream of the cavitation point and inside the chamber when no cooling device was used. Cavitation is a state in which an orifice has vaporized a liquid.

Comparing FIG. 48 without cooling with FIG. 45(1) with cooling, it can be seen that for test NC (without cooling) in FIG. 48, the pressure recorded in the chamber and downstream of the boiling point during combustion decreased due to nozzle erosion. The pressure drop inside the chamber causes a decreased performance as an oxidizer, which leads to a decrease in the propulsion system's performance.

FIG. 49 is a diagram showing the performance of a cooling device and a cooling system of the present disclosure, where the orifice arrangements were changed to change the cavitation points, as shown in FIG. 36.

FIG. 49(1) shows the chamber pressure of a coolant tank. FIG. 49(2) shows the temperature at a distance of 12 mm from the nozzle.

FIG. 49(1) indicates that combustion became unstable in the alternative configuration, and pressure oscillation occurred inside the chamber.

FIG. 49(2) indicates that the cooling ability is inferior to that of FIG. 46(1) with cooling.

### 8. Predetermined Distance Between a Nozzle Throat Part and Cooling Channels (Ds) and Effective Widths of Cooling Channels

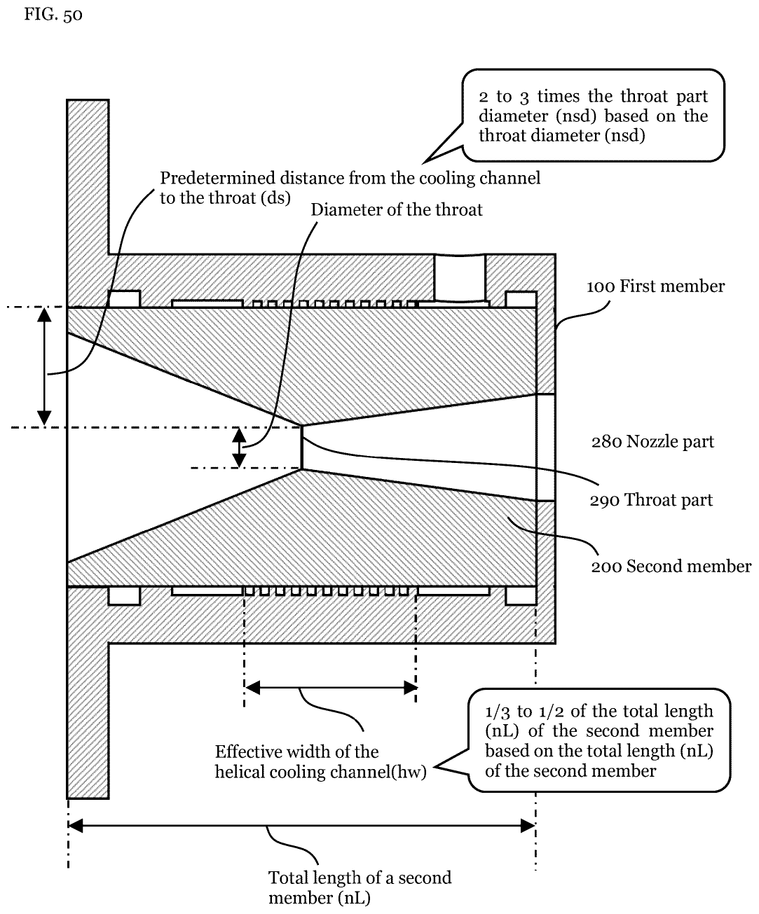

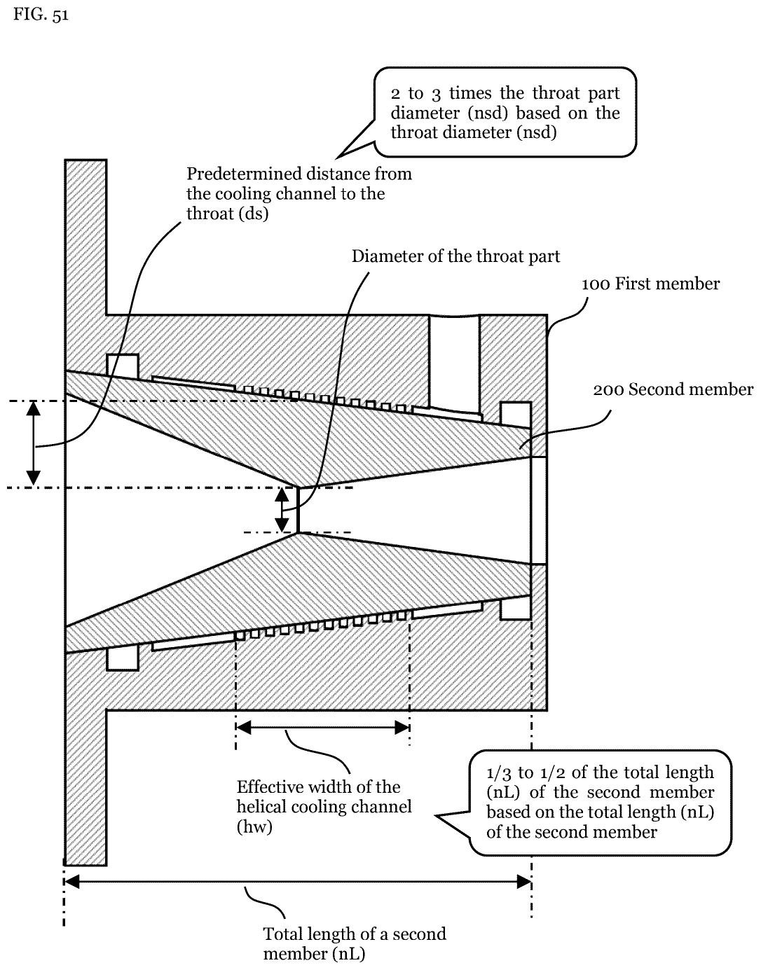

We will describe, using FIGS. 50 and 51, relationships between a predetermined distance between a nozzle throat part and a cooling channel (ds) and the diameter of a throat part, and the relationships between the effective width of a cooling channel (hw) and a nozzle total length.

FIG. 50 is a diagram showing the positional relationship between a cooling channel and a throat part, and the effective width with respect to the total length (when the second member is cylindrical).

FIG. 51 is a diagram showing the positional relationship between a cooling channel and a throat part, and the effective width with respect to the total length (when the second member is tapered). FIG. 51 shows a tapered shape having a wide inlet and a narrow outlet, and the tapered shape of the opposite pattern having a narrow inlet and a wide outlet has the same tapered shape, so its description is omitted.

As shown in FIGS. 51 and 52, to achieve the cooling ability of the present disclosure, the predetermined distance to the cooling channel and throat part 290 (ds) is preferably based on the diameter of the throat part (nsd) and is preferably 2 to 3 times the diameter of the throat part (nsd).

In addition, the effective width of the helical cooling channel (hw) is preferably based on the total length of the second member (nL), and one-third to one-half the length of the total length of the second member (nL).

The reason why the diameter of the throat portion (nsd) and the total length of the second member (nozzle) (nL) are used as the basis is that they are significant parameters: the extent to which the diameter of the throat part is narrowed relative to the total length of the nozzle determines the temperature of the combustion material or the combustion gas velocity.

### 9. Summary

As mentioned above, the configuration of the present disclosure is well intended to: first, provide a helical cooling channel; second, set the distance between a cooling channel and a nozzle part; third, tune the effective width of a cooling channel to an appropriate range; fourth, provide a helical cooling channel for each channel section; fifth, optimize the number of helical cooling channels; sixth, adjust the material's thermal conductivity around the nozzle to an appropriate range; and seventh, optimize the position of an orifice to use nitrous oxide in the cooling channel stably. However, it is not necessary to include all items, and it is sufficient to include at least the first one and one or more of the other items.

According to the present disclosure, due to this consideration or ingenuity, it is possible to provide a highly safe cooling system free from explosive phenomena, even when nitrous oxide is used as an oxidizer for a hybrid rocket engine.

The present disclosure also indicates the possibility of suppressing nozzle erosion while balancing the cooling ability and the coolant's temperature rise.

### INDUSTRIAL APPLICABILITY

The nozzle cooling device and regenerative cooling system of the present disclosure can also be used as a nozzle cooling device or cooling system for liquid fuel rockets and solid fuel rockets other than hybrid rocket engines.

### REFERENCES SIGNS LIST

100 first member
101 body part of a first member
102 flange part of a first member
104 rear opening
105 front opening
110 coolant inlet (or outlet)
120 introduction zone (or recovery zone) to introduce coolant to coolant channel
130 helical groove part
131 cooling channel inlet for CH1
132 cooling channel inlet for CH2
133 cooling channel inlet for CH3
135 helical cooling channel
140 helical protrusion part (fin)
150 recovery zone (or introduction zone) to recover coolant from cooling channel
160 inner circumferential surface of a first member
170 outlet (or inlet)
180 flange part
200 second member
260 outer circumferential surface of a second member
280 nozzle part
282 nozzle inlet
284 nozzle outlet
290 throat part
300 nozzle cooling device formed by fitting a first member and a second member together
400 hybrid rocket engine body
410 injector
420 ignition device
430 solid fuel
440 combustion chamber
450 oxidizer inlet
500 coolant (and oxidizer) tank
510 phase change orifice
520 cooling channel piping
530 oxidizer piping

### [First Member Parameters]

The length of the body part of a first member (L1)
Thickness of the flange part of a first member (D2)
Total length of a first member (L1+D2)
Diameter of the body part of a first member (D1Dd)
Diameter of the coolant inlet of a first member (C1)
Diameter of the coolant outlet of a first member (C2)
Diameter of the inner surface of a first member (D1Nd)
Thickness of the body part of a first member (D1)
Diameter of the rear opening of a first member
Thickness of the rear opening part of a first member (D1)
Width of an introduction zone (K1)
Width of a recovery zone (K2)

### [Second Member Parameters]

Total length of a second member (nL)
Diameter of a nozzle inlet (nid)
Distance from a nozzle inlet to a throat part (dsl)
Diameter of a nozzle outlet (nod)
Diameter of a second member (D2Gd)
Diameter of a throat part (nsd)
Distance from the outer surface to the throat part of a second member (D2ds)

### [Cooling Channel Parameters]

fin width (wf)
Cooling channel width (wch)
Cooling channel depth (chd)
   [Parameters for the Situation, where Combing a First Member and a Second Member]
A predetermined distance to the cooling channel and throat part (ds)
Basically, Dsds≈ds
Effective width of a helical cooling channel (hw)

What is claimed is:

1. A cooling device having a coolant inlet and a coolant outlet to cool a rocket engine nozzle, the cooling device comprising:
a first member, comprising an inner circumstance surface having a substantially cylindrical or tapered shape on the inner circumstance surface,
including I channels provided over a part or all of the inner circumstance surface, wherein “I” is an integer of two or more to n, and a helical groove part on each channel;
a second member, comprising:
an outer shape being as a substantially cylindrical or tapered shape, an outer circumstance surface being substantially a same shape as the inner circumferential surface of the first member, wherein
upon the second member being fitted onto the inner circumferential surface of the first member, the outer circumferential surface of the second member being a shape to be substantially flushed to the inner circumferential surface of the first member;
a nozzle-shaped cavity part being provided inside of the second member for the sake of forming a nozzle part of the rocket engine; and
a predetermined distance (ds) being secured between a throat part of the nozzle part and the outer circumferential surface; and
a device to form a helical cooling channel between the inner circumferential surface of the first member and the outer circumferential surface of the second member by assembling the first member and the second member, the device comprising:
a tube part being provided as corresponding to the helical groove part shape between
the helical groove part provided at the inner circumferential surface of the first member and
the outer circumferential surface of the second member, and thereby the helical cooling channel being formed; and
the helical cooling channel being provided at a position spaced a predetermined distance (ds) from the throat part formed inside of the second member,
followed by preventing coolant running in the helical cooling channel from being excessively heated and helping the coolant perform a predetermined cooling ability, upon a combustion gas of the rocket engine passing through the throat part.

2. The cooling device for a rocket engine nozzle as claimed in claim 1, the first member is characterized in that
the helical groove part provided at a position corresponding to the throat part of the nozzle part, the position being a part of the inner circumferential surface of the first member;
upon forming the helical cooling channel by forming the tube part corresponding to the shape of the helical groove part between the helical groove part and the outer circumferential surface of the second member,
the helical cooling channel being formed at a position spaced the predetermined distance (ds) from the throat part formed inside of the second member and, furthermore
an effective width of the helical cooling channel (hw) being shorter than a total length of the nozzle part.

3. The cooling device for a rocket engine nozzle, as claimed in claim 2, wherein
the second member being made of a predetermined thermal conductive material including graphite, whereby
upon a combustion gas of the rocket engine passing through the nozzle part, transferring heat received at the nozzle part of the second member to a coolant running through the helical cooling channel via the predetermined thermal conductive material, then
demonstrating a predetermined cooling capacity against the nozzle part by a heat-exchanging function of the coolant;
the helical cooling channel being formed at the position spaced the predetermined distance (ds) from the throat part formed inside of the second member;
providing a device for decreasing a temperature gradually depending on the distance from the nozzle part, which is a heat-source, by using the predetermined thermal conductive material; and then
upon the combustion gas of the rocket engine passing through the nozzle part, preventing the coolant running in the helical cooling channel from being excessively heated.

4. The cooling device for a rocket engine nozzle as claimed in any one of claims 2 and 3, wherein
upon using nitrous oxide as the coolant running in the helical cooling channel,
for a sake of preventing the combustion gas of the rocket engine from suddenly heating the nitrous oxide as the coolant and causing an explosive phenomenon, thereby the helical cooling channel or the nozzle part being destroyed,
forming the helical cooling channel at a position spaced the predetermined distance (ds) from the throat part of the nozzle part formed inside of the second member; and
the effective width of the helical cooling channel being shorter than the total length of the nozzle throat.

5. The cooling device for a rocket engine nozzle as claimed in any one of claims 2 to 3, wherein,
the predetermined distance (ds) provided between the helical cooling channel and the throat part of the nozzle part is at least twice a diameter of the throat part of the nozzle part (nsd), and
the effective width of the helical cooling channel (hw) having a width of one-third to one-half with respect to a total length of the second member (nzl).

6. The cooling device for a rocket engine nozzle as claimed in any one of claims 2 to 3, the first member is characterized in that:
the helical groove part is provided at the position corresponding to the throat part of the nozzle part, the position being a part of the inner circumferential surface of the first member; and
upon forming a tube part corresponding to the helical groove part shape between the helical groove part and the second member, thereby forming the helical cooling channel,
the helical groove part having a swirl angle α of 2 to 10 degrees.

7. The cooling device for a rocket engine nozzle as claimed in any one of claims 2 to 3, the first member is characterized in that:
the helical groove part is provided at the position corresponding to the throat part of the nozzle part, the position being a part of the inner circumferential surface of the first member; and
upon forming a tube part corresponding to the helical groove part shape between the helical groove part and the second member,
a number of channels of the helical groove part “I” being 2 to 8.

8. The cooling device for a rocket engine nozzle, as claimed in claim 7, the first member is characterized in that:
an introduction zone for introducing a coolant into the cooling channel is provided on a portion of the inner circumferential surface thereon and, furthermore
a recovery zone for recovering the coolant having elevated temperature due to running through the cooling channel is provided, and thereby
even when the number of cooling channels I is as small as 2 to 8, allowing smooth introduction and recovery of the coolant to the cooling channels.

9. A regenerative cooling system for a hybrid rocket engine, especially for a nozzle part of the hybrid rocket engine, the regenerative cooling system comprising:
an oxidizer in a liquid phase;
an oxidizer storage part for storing the oxidizer in a liquid phase;
an oxidizer injection part for injecting the oxidizer;
a solid fuel part serving as a rocket propellant; an ignition part for causing a combustion reaction between the oxidizer and the solid fuel; a nozzle part for accelerating the combustion gas generated by the combustion of the solid fuel to supersonic speed; and
a cooling channel for utilizing the oxidizer to cool the nozzle section, wherein
a first member, as a member for regenerative cooling, comprising a substantially cylindrical or tapered shape on an inner circumstance surface,
including I channels provided over a part or all of the inner circumstance surface, wherein “I” is an integer of two or more to n, and a helical groove part on each channel;
a second member, as a member including the nozzle part that is a target of regenerative cooling, the second member comprising:
an outer shape being as a substantially cylindrical or tapered shape;
an outer circumstance surface being substantially a same shape as the inner circumferential surface of the first member, wherein
upon the second member being fitted onto the inner circumferential surface of the first member, the outer circumferential surface of the second member being a shape to be substantially flushed to the inner circumferential surface of the first member;
a nozzle-shaped cavity part being provided inside of the second member for the sake of forming a nozzle part of the rocket engine; and
a predetermined distance (ds) being secured between a throat part of the nozzle part and the outer circumferential surface; and
a device to form a helical cooling channel between the inner circumferential surface of the first member and the outer circumferential surface of the second member by assembling the first member and the second member, the device comprising:
a tube part being provided as corresponding to the helical groove part shape between the helical groove part provided at the inner circumferential surface of the first member and
the outer circumferential surface of the second member, and thereby the helical cooling channel being formed;
the helical cooling channel being provided at a position spaced a predetermined distance (ds) from the throat part formed inside of the second member,
followed by preventing coolant running in the helical cooling channel from being excessively heated and helping the coolant perform a predetermined cooling ability, upon a combustion gas of the rocket engine passing through the throat part;
a cooling channel piping for guiding the oxidizer from the oxidizer storage part to the cooling channel, by which the oxidizer expresses an oxidization ability; and an oxidizer piping for supplying the oxidizer, which passes through the cooling channel into an oxidizer injection part and is then the oxidizer being expressed an oxidization ability.

10. The regenerative cooling system for a rocket engine, as claimed in claim 9, the first member is characterized in that:
the helical groove part provided at a position corresponding to the throat part of the nozzle part, the position being a part of the inner circumferential surface of the first member;
upon forming a helical cooling channel by forming a tube part corresponding to the helical groove part shape between the helical groove part and the second member,
the helical cooling channel being formed at the position spaced the predetermined distance (ds) from the throat part formed inside of the second member; and
an effective width of the helical cooling channel (hw) being shorter than a total length of the nozzle part.

11. The regenerative cooling system for a hybrid rocket engine, as claimed in claim 10, wherein,
the second member being made of a predetermined thermal conductive material including graphite, whereby
upon a combustion gas of the rocket engine passing through the nozzle part, transferring heat received at the nozzle part of the second member to a coolant running through the helical cooling channel via the predetermined thermal conductive material, then
demonstrating a predetermined cooling capacity against the nozzle part by a heat-exchanging function of the coolant;
the helical cooling channel being formed at the position spaced the predetermined distance (ds) from the throat part of the nozzle part formed inside of the second member;
providing a device for decreasing a temperature gradually depending on the distance from the nozzle part, which is a heat-source, by using the predetermined thermal conductive material; and then
upon the combustion gas of the rocket engine passing through the nozzle part, preventing the coolant running in the helical cooling channel from being excessively heated.

12. The regenerative cooling system for a hybrid rocket engine, as claimed in claim 10, wherein,
upon using nitrous oxide as the coolant running in the helical cooling channel,
for a sake of preventing the combustion gas of the rocket engine from suddenly heating the nitrous oxide as the coolant and causing an explosive phenomenon, thereby the helical cooling channel or the nozzle part being destroyed,
forming the helical cooling channel at a position spaced the predetermined distance (ds) from the throat part of the nozzle part formed inside of the second member, and
the effective width of the helical cooling channel being shortened than the total length of the nozzle throat.

13. The regenerative cooling system for a hybrid rocket engine, as claimed in claim 10, wherein,
the predetermined distance (ds) provided between the helical cooling channel and the throat part of the nozzle part is at least twice a diameter of the second member (nzd), and
the effective width of the helical cooling channel (hw) having a width of one-third to one-half with respect to a total length of the second member (nzl).

14. The regenerative cooling system for a hybrid rocket engine, as claimed in claim 10, the first member is characterized in that:
the helical groove part is provided at the position corresponding to the throat part of the nozzle part, the position being a part of the inner circumferential surface of the first member; and
upon forming the tube part corresponding to the helical groove part shape between the helical groove part and the second member, thereby forming the helical cooling channel,
the helical groove part having a swirl angle α of 2 to 10 degrees.

15. The regenerative cooling system for a hybrid rocket engine, as claimed in claim 10, the first member is characterized in that:
the helical groove part is provided at the position corresponding to the throat part of the nozzle part, the position being a part of the inner circumferential surface of the first member; and
upon forming the tube part corresponding to the helical groove part shape between the helical groove part and the second member,
the number of channels of the helical groove part being 2 to 8.

16. The regenerative cooling system for a hybrid rocket engine, as claimed in claim 15, the first member is characterized in that:
an introduction zone for introducing a coolant into the cooling channel is provided on a portion of the inner circumferential surface thereon and, furthermore
a recovery zone for recovering the coolant having elevated temperature due to running through the cooling channel is provided, thereby
even when the number of cooling channels I is as small as 2 to 8, allowing smooth introduction and recovery of the coolant to the cooling channels.

17. The regenerative cooling system for a hybrid rocket engine, as claimed in any one of claims 9 to 16,
a phase change orifice being arranged at the cooling channel piping extending from the oxidizer storage part to the cooling channel, by which
the oxidizer stored in the oxidizer storage part is vaporized from a liquid phase to a gas phase, and then delivered into the helical cooling channel.
